(19) United States
(12) Patent Application Publication
(10) Pub. No.: US 2024/0397471 A1
(43) Pub. Date: Nov. 28, 2024

(54) DEVICE/NETWORK EFFICIENT UE POSITIONING BASED ON TRS WITH ON-DEMAND PRS FRAMEWORK

(71) Applicant: QUALCOMM Incorporated, San Diego, CA (US)

(72) Inventors: Weimin DUAN, San Diego, CA (US); Alexandros MANOLAKOS, Athens (GR); Huilin XU, Temecula, CA (US)

(21) Appl. No.: 18/700,665

(22) PCT Filed: Nov. 8, 2022
(86) PCT No.: PCT/US2022/049315

§ 371 Date: Apr. 11, 2024

(30) Foreign Application Priority Data
Dec. 21, 2021 (GR) 20210100901

(51) Int. Cl. H04W 64/00; H04L 5/00

(52) U.S. Cl. CPC H04W 64/00; H04L 5/0048

(57) ABSTRACT

Aspects presented herein may enable a network entity to configure other types of reference signals, such as reference signals configured for communications, for positioning measurements. In one aspect, a network entity, such as an LMF, transmits, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session. The network entity receives, from each of the plurality of base stations, the capability report. The network entity selects at least some of the plurality of base stations and a signal pattern configuration for the UE positioning session based on the capability report received from each of the plurality of base stations.

### CROSS-REFERENCE TO RELATED APPLICATION

This application claims the benefit of Greek patent application No. 20210100901, entitled “DEVICE/NETWORK EFFICIENT UE POSITIONING BASED ON TRS WITH ON-DEMAND PRS FRAMEWORK” and filed on Dec. 21, 2021, which is expressly incorporated by reference herein in its entirety.

### TECHNICAL FIELD

The present disclosure relates generally to communication systems, and more particularly, to wireless communications involving positioning.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies. Some communication systems may also support a number of cellular network-based positioning technologies, where the geographic location of a wireless device may be determined based on measuring radio signals exchanged between the wireless device and other wireless devices. For example, a distance between a wireless device and a transmission reception point (TRP) may be estimated based on the time it takes for a reference signal (e.g., a positioning reference signal (PRS)) transmitted from the TRP to reach the wireless device. Other examples of cellular network-based positioning technologies may include downlink-based, uplink-based, and/or downlink-and-uplink-based positioning methods.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a plurality of base stations, a request for a capability report indicating at least one of whether the plurality of base stations have a capability to formulate a reference signal (RS) for communication as a positioning reference signal (PRS) for a user equipment (UE) positioning session or whether the plurality of base stations have a capability to transmit a PRS dedicated for positioning for the UE positioning session. The apparatus receives, from each of the plurality of base stations, the capability report. The apparatus selects at least some of the plurality of base stations and a signal pattern configuration for the UE positioning session based on the capability report received from each of the plurality of base stations.

In an aspect of the disclosure, a method, a computer-readable medium, and an apparatus are provided. The apparatus receives, from a network entity, a request for a capability report indicating at least one of whether the base station has a capability to formulate an RS for communication as a PRS for a UE positioning session or whether the base station has a capability to transmit a PRS dedicated for positioning for the UE positioning session. The apparatus switches between the communication mode and the RF sensing mode during a third time duration of the symbol, the first time duration, the second time duration, and the third time duration not overlapping with each other.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5A is a diagram illustrating an example of downlink-positioning reference signal (DL-PRS) transmitted from multiple transmission-reception points (TRPs) in accordance with various aspects of the present disclosure.

FIG. 5B is a diagram illustrating an example of uplink-sounding reference signal (UL-SRS) transmitted from a UE in accordance with various aspects of the present disclosure.

FIG. 6 is a diagram illustrating an example of estimating a position of a UE based on multi-round trip time (RTT) measurements from multiple TRPs in accordance with various aspects of the present disclosure.

FIG. 7 is a communication flow illustrating an example multi-RTT positioning procedure in accordance with various aspects of the present disclosure.

FIG. 8 is a communication flow illustrating an example on-demand DL-PRS procedure in accordance with various aspects of the present disclosure.

FIG. 9 is a communication flow illustrating an example of an on-demand DL-PRS/DL-RS procedure based on reusing TRS for network/device efficient UE positioning in accordance with various aspects of the present disclosure.

FIG. 10 is a flowchart of a method of wireless communication in accordance with aspects presented herein.

FIG. 11 is a flowchart of a method of wireless communication in accordance with aspects presented herein.

FIG. 12 is a diagram illustrating an example of a hardware implementation for an example apparatus in accordance with aspects presented herein.

FIG. 13 is a flowchart of a method of wireless communication in accordance with aspects presented herein.

FIG. 14 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

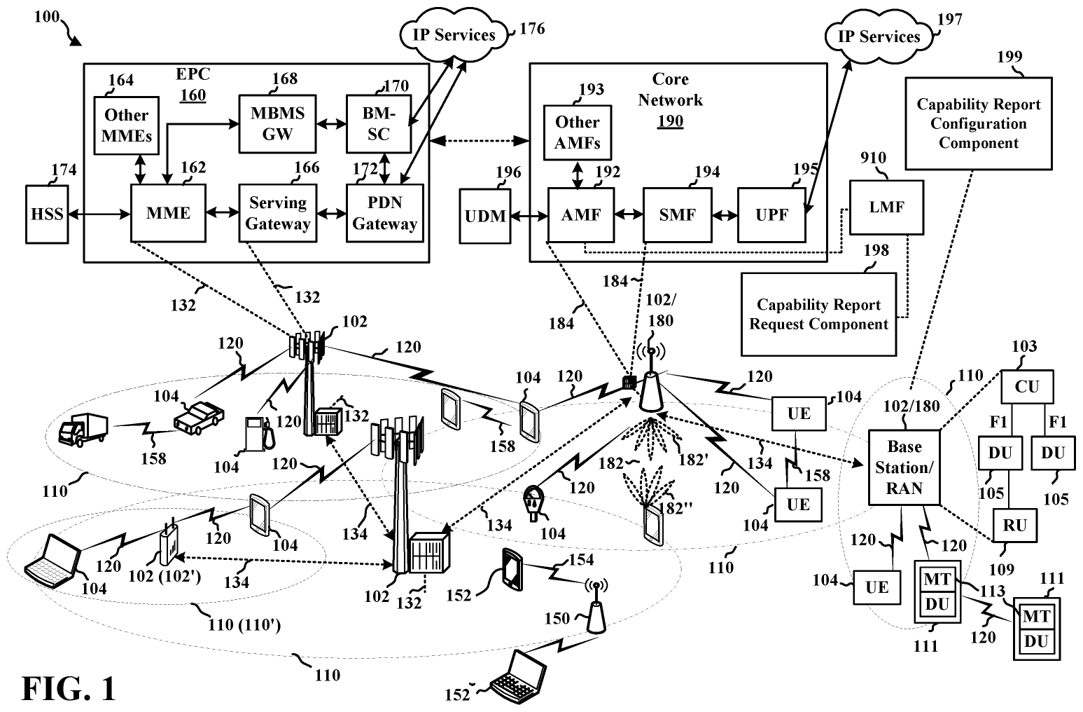

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may improve power efficiency and latency for UE positioning. Aspects presented herein may enable a UE to utilize other types of reference signals, such as reference signals configured for communications, for positioning measurements, such that power consumption at both the UE and the network (e.g., base station, location server, etc.) may be reduced during a UE positioning session.

In certain aspects, a network entity (e.g., the LMF 910), may include a capability report request component 198 configured to configure other types of reference signals, such as reference signals configured for communications, for positioning measurements. In one configuration, the capability report request component 198 may be configured to transmit, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session. In such configuration, the capability report request component 198 may receive, from each of the plurality of base stations, the capability report. In such configuration, the capability report request component 198 may select at least some of the plurality of base stations and a signal pattern configuration for the UE positioning session based on the capability report received from each of the plurality of base stations.

In certain aspects, a base station 102/180 may include a capability report configuration component 199 configured to report the type of PRS configuration supported by the base station and whether the base station is capable of formulating RS for communication to RS for positioning. In one configuration, the capability report configuration component 199 may be configured to receive, from a network entity (e.g., the LMF 910), a request for a capability report indicating at least one of whether the base station has a capability to formulate an RS for communication as a PRS for a UE positioning session or whether the base station has a capability to transmit a PRS dedicated for positioning for the UE positioning session. In such configuration, the capability report configuration component 199 may transmit, to the network entity, the capability report.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station 102 or 180 may be referred as a RAN and may include aggregated or disaggregated components. As an example of a disaggregated RAN, a base station may include a central unit (CU) 103, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 103, the DU 105, and the RU 109. A RAN may be disaggregated with a split between the CU 103 and an aggregated DU/RU. The CU 103 and the one or more DUs 105 may be connected via an F1 interface. A DU 105 and an RU 109 may be connected via a fronthaul interface. A connection between the CU 103 and a DU 105 may be referred to as a midhaul, and a connection between a DU 105 and an RU 109 may be referred to as a fronthaul. The connection between the CU 103 and the core network may be referred to as the backhaul. The RAN may be based on a functional split between various components of the RAN, e.g., between the CU 103, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 103 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 103 and a DU 105. IAB nodes 111 may include a DU 105 and a mobile termination (MT) 113. The DU 105 of an IAB node 111 may operate as a parent node, and the MT 113 may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (52.6 GHZ-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

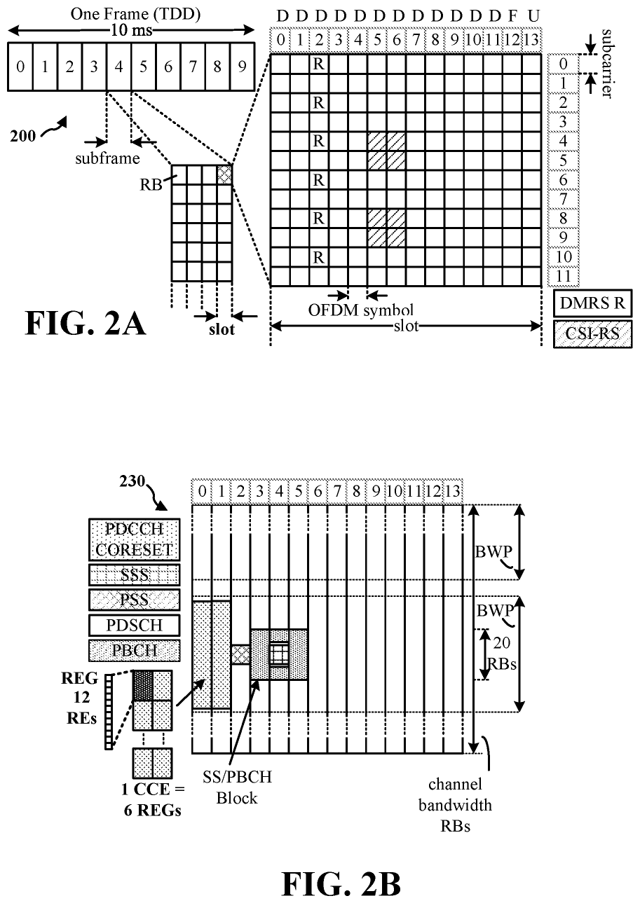

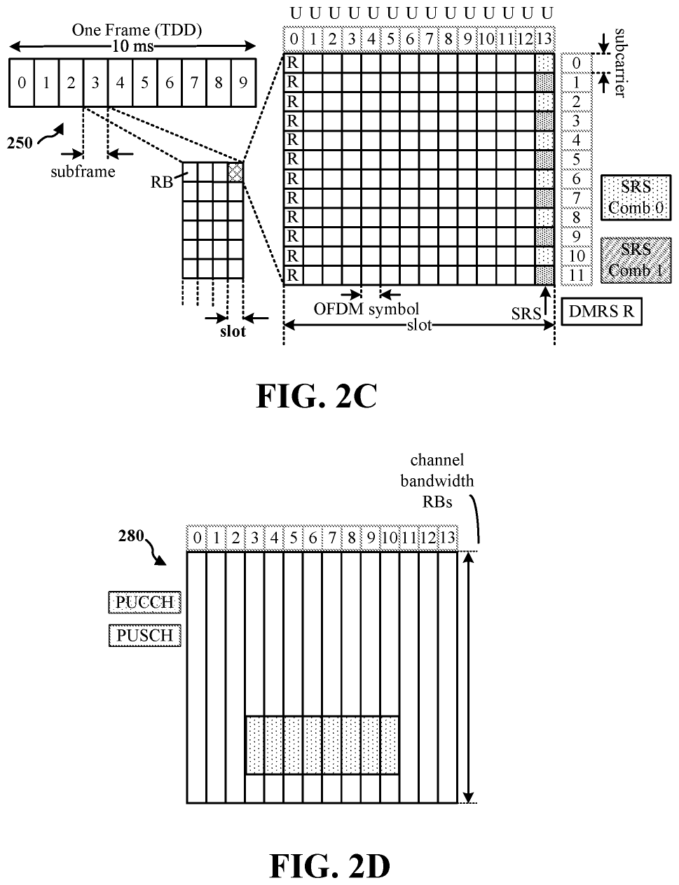

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

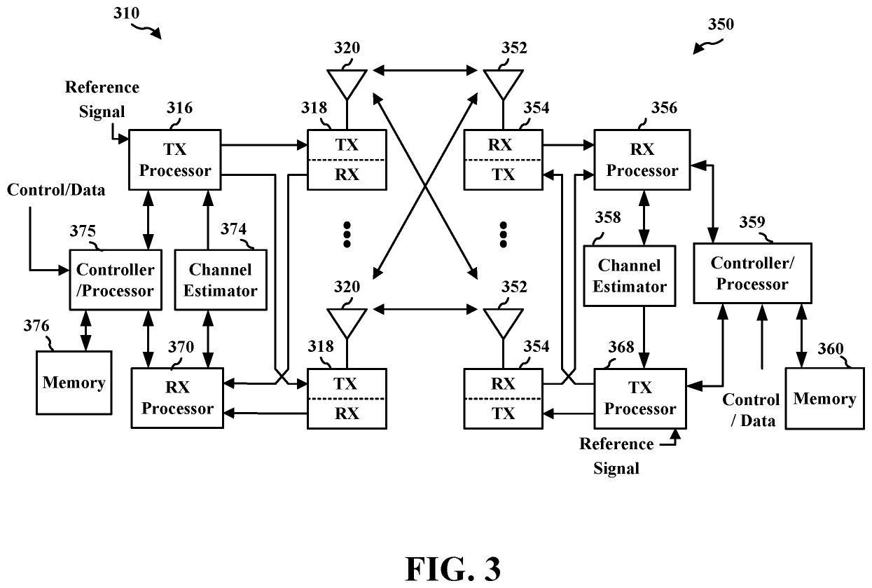

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some examples, at least one of the TX processor 368, the RX processor 356, and the controller/processor 359 may be configured to perform aspects in connection with the capability report request component 198 and/or the capability report request component 199 of FIG. 1.

A network may support a number of cellular network-based positioning technologies, such as downlink-based, uplink-based, and/or downlink-and-uplink-based positioning methods. Downlink-based positioning methods may include an observed time difference of arrival (OTDOA) (e.g., in LTE), a downlink time difference of arrival (DL-TDOA) (e.g., in NR), and/or a downlink angle-of-departure (DL-AoD) (e.g., in NR). In an OTDOA or DL-TDOA positioning procedure, a UE may measure the differences between each time of arrival (ToA) of reference signals (e.g., positioning reference signals (PRSs)) received from pairs of base stations, referred to as reference signal time difference (RSTD) measurements or time difference of arrival (TDOA) measurements, and report them to a positioning entity (e.g., a location management function (LMF)). For example, the UE may receive identifiers (IDs) of a reference base station (which may also be referred to as a reference cell or a reference gNB) and at least one non-reference base station in assistance data (AD). The UE may then measure the RSTD between the reference base station and each of the non-reference base stations. Based on the known locations of the involved base stations and the RSTD measurements, the positioning entity may estimate a location of the UE. In other words, a position of the UE may be estimated based on measuring reference signals transmitted between the UE and one or more base stations and/or transmission-reception points (TRPs) of the one or more base stations. As such, the PRSs may enable UEs to detect and measure neighbor TRPs, and to perform positioning based on the measurement. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

In some examples, the term “TRP” may refer to one or more antennas of a base station whereas the term “base station” may refer to a complete unit (e.g., the base station 102/180) that includes aggregated or disaggregated components, such as described in connection with FIG. 1. For example, as an example of a disaggregated RAN, a base station may include CU, one or more DUs, one or more RUs, and/or one or more TRPs. One or more disaggregated components may be located at different locations. For example, different TRPs may be located at different geographic locations. In another example, a TRP may refer to a set of geographically co-located antennas (e.g., antenna array (with one or more antenna elements)) supporting transmission point (TP) and/or reception point (RP) functionality. Thus, a base station may transmit signal to and/or receive signal from other wireless device (e.g., a UE, another base station, etc.) via one or more TRPs. For purposes of the present disclosure, in some examples, the term “TRP” may be used interchangeably with the term “base station.”

For DL-AoD positioning, the positioning entity may use a beam report from the UE of received signal strength measurements of multiple downlink transmit beams to determine the angle(s) between the UE and the transmitting base station(s). The positioning entity may then estimate the location of the UE based on the determined angle(s) and the known location(s) of the transmitting base station(s).

Uplink-based positioning methods may include UL-TDOA and UL-AoA. UL-TDOA is similar to DL-TDOA, but is based on uplink reference signals (e.g., sounding reference signals (SRSs)) transmitted by the UE. For UL-AoA positioning, one or more base stations may measure the received signal strength of one or more uplink reference signals (e.g., SRSs) received from a UE on one or more uplink receive beams. The positioning entity may use the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods may include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or a base station), which transmits an RTT response signal (e.g., an SRS or a PRS) back to the initiator. The RTT response signal may include the difference between the ToA of the RTT measurement signal and the transmission time of the RTT response signal, referred to as the reception-to-transmission (Rx-Tx) time difference. The initiator may calculate the difference between the transmission time of the RTT measurement signal and the ToA of the RTT response signal, referred to as the transmission-to-reception (Tx-Rx) time difference. The propagation time (also referred to as the “time of flight”) between the initiator and the responder may be calculated from the Tx-Rx and Rx-Tx time differences. Based on the propagation time and the known speed of light, the distance between the initiator and the responder may be determined. For multi-RTT positioning, a UE may perform an RTT procedure with multiple base stations to enable its location to be determined (e.g., using multilateration) based on the known locations of the base stations. RTT and multi-RTT methods may be combined with other positioning techniques, such as UL-AoA and DL-AoD, to improve location accuracy.

The E-CID positioning method may be based on radio resource management (RRM) measurements. In E-CID, the UE may report the serving cell ID and the timing advance (TA), as well as the identifiers, estimated timing, and signal strength of detected neighbor base stations. The location of the UE is then estimated based on this information and the known locations of the base station(s).

To assist positioning operations, a location server (e.g., a location server, an LMF, or an SLP) may provide assistance data (AD) to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations (e.g., in periodically broadcasted overhead messages, etc.). In some cases, the UE may be able to detect neighbor network nodes without the use of assistance data.

In the case of an OTDOA or DL-TDOA positioning procedure, the assistance data may further include an expected RSTD value and an associated uncertainty (e.g., a search space window) around the expected RSTD. In some cases, the value range of the expected RSTD may be plus-minus (+/−) 500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs. In this context, “RSTD” may refer to one or more measurements indicative of a difference in time of arrival between a PRS transmitted by a base station, referred to herein as a “neighbor base station” or a “measuring base station,” and a PRS transmitted by a reference base station. A reference base station may be selected by a location server and/or by a UE to provide good or sufficient signal strength observed at a UE, such that a PRS may be more accurately and/or more quickly acquired and/or measured, such as without any special assistance from a serving base station.

A location estimate may also be referred to as a position estimate, location, position, position fix, fix, or the like. A location estimate may be geodetic and include coordinates (e.g., latitude, longitude, and possibly altitude) or may be civic and include a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence). For purposes of the present disclosure, reference signals may include PRS, tracking reference signals (TRS), phase tracking reference signals (PTRS), cell-specific reference signals (CRS), CSI-RS, demodulation reference signals (DMRS), PSS, SSS, SSBs, SRS, etc., depending on whether the illustrated frame structure is used for uplink or downlink communication. In some examples, a collection of resource elements (REs) that are used for transmission of PRS may be referred to as a “PRS resource.” The collection of resource elements may span multiple PRBs in the frequency domain and one or more consecutive symbol(s) within a slot in the time domain. In a given OFDM symbol in the time domain, a PRS resource may occupy consecutive PRBs in the frequency domain. In other examples, a “PRS resource set” may refer to a set of PRS resources used for the transmission of PRS signals, where each PRS resource may have a PRS resource ID. In addition, the PRS resources in a PRS resource set may be associated with a same TRP. A PRS resource set may be identified by a PRS resource set ID and may be associated with a particular TRP (e.g., identified by a TRP ID). In addition, the PRS resources in a PRS resource set may have a same periodicity, a common muting pattern configuration, and/or a same repetition factor across slots. The periodicity may be a time from a first repetition of a first PRS resource of a first PRS instance to the same first repetition of the same first PRS resource of the next PRS instance. For example, the periodicity may have a length selected from 2\hat{ }μ*{4, 5, 8, 10, 16, 20, 32, 40, 64, 80, 160, 320, 640, 1280, 2560, 5120, 10240} slots, where μ=0, 1, 2, 3. The repetition factor may have a length selected from {1, 2, 4, 6, 8, 16, 32} slots. A PRS resource ID in a PRS resource set may be associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” In some examples, a “PRS instance” or “PRS occasion” may be one instance of a periodically repeated time window (such as a group of one or more consecutive slots) where PRS are expected to be transmitted. A PRS occasion also may be referred to as a “PRS positioning occasion,” a “PRS positioning instance,” a “positioning occasion,” “a positioning instance,” a “positioning repetition,” or simply an “occasion,” an “instance,” and/or a “repetition,” etc.

A positioning frequency layer (PFL) (which may also be referred to as a “frequency layer”) may be a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN-ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to a component carrier (CC) and a BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

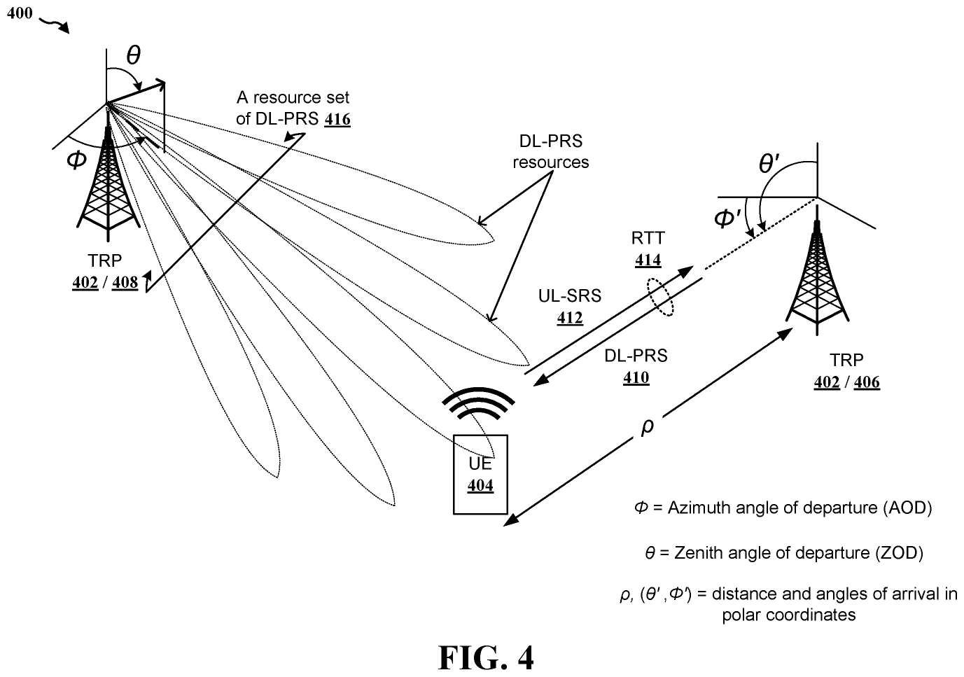

FIG. 4 is a diagram 400 illustrating an example of a UE positioning based on reference signal measurements in accordance with various aspects of the present disclosure. In one example, a location of UE 404 may be estimated based on multi-cell round trip time (multi-RTT) measurements, where multiple TRPs 402 may perform round trip time (RTT) measurements for signals transmitted to and received from the UE 404 to determine the approximate distance of UE 404 with respect to each of the multiple TRPs 402. Similarly, the UE 404 may perform RTT measurements for signals transmitted to and received from the TRPs 402 to determine the approximate distance of each TRP with respect to the UE 404. Then, based at least in part on the approximate distances of UE 404 with respect to the multiple TRPs 402, a location management function (LMF) that is associated with the TRPs 402 and/or the UE 404 may estimate the position of UE 404. For example, a TRP 406 may transmit at least one downlink positioning reference signal (DL-PRS) 410 to the UE 404, and may receive at least one uplink sounding reference signal (UL-SRS) 412 transmitted from the UE 404. Based at least in part on measuring an RTT 414 between the DL-PRS 410 transmitted and the UL-SRS 412 received, a serving base station associated with the TRP 406 or an LMF associated with the TRP 406 may identify the position of UE 404 (e.g., distance) with respect to the TRP 406. Similarly, the UE 404 may transmit UL-SRS 412 to the TRP 406, and may receive DL-PRS 410 transmitted from the TRP 406. Based at least in part on measuring the RTT 414 between the UL-SRS 412 transmitted and the DL-PRS 410 received, the UE 404 or an LMF associated with the UE 404 may identify the position of TRP 406 with respect to the UE 404. The multi-RTT measurement mechanism may be initiated by the LMF that is associated with the TRP 406/408 and/or the UE 404. A TRP may configure UL-SRS resources to a UE via radio resource control (RRC) signaling. In some examples, the UE and the TRP may report the multi-RTT measurements to the LMF, and the LMF may estimate the position of the UE based on the reported multi-RTT measurements.

In other examples, a position of a UE may be estimated based on multiple antenna beam measurements, where a downlink angle of departure (DL-AoD) and/or uplink angle of arrival (UL-AoA) of transmissions between a UE and one or more TRPs may be used to estimate the position of the UE and/or the distance of the UE with respect to each TRP. For example, referring back to FIG. 4, with regard to the DL-AoD, the UE 404 may perform reference signal received power (RSRP) measurements for a set of DL-PRS 416 transmitted from multiple transmitting beams (e.g., DL-PRS beams) of a TRP 408, and the UE 404 may provide the DL-PRS beam measurements to a serving base station (or to the LMF associated with the base station). Based on the DL-PRS beam measurements, the serving TRP or the LMF may derive the azimuth angle (e.g., Φ) of departure and the zenith angle (e.g., θ) of departure for DL-PRS beams of the TRP 408. Then, the serving TRP or the LMF may estimate the position of UE 404 with respect to the TRP 408 based on the azimuth angle of departure and the zenith angle of departure of the DL-PRS beams. Similarly, for the UL-AoA, a position of a UE may be estimated based on UL-SRS beam measurements measured at different TRPs, such as at the TRPs 402. Based on the UL-SRS beam measurements, a serving base station or an LMF associated with the serving base station may derive the azimuth angle of arrival and the zenith angle of arrival for UL-SRS beams from the UE, and the serving base station or the LMF may estimate the position of the UE and/or the UE distance with respect to each of the TRPs based on the azimuth angle of arrival and the zenith angle of arrival of the UL-SRS beams.

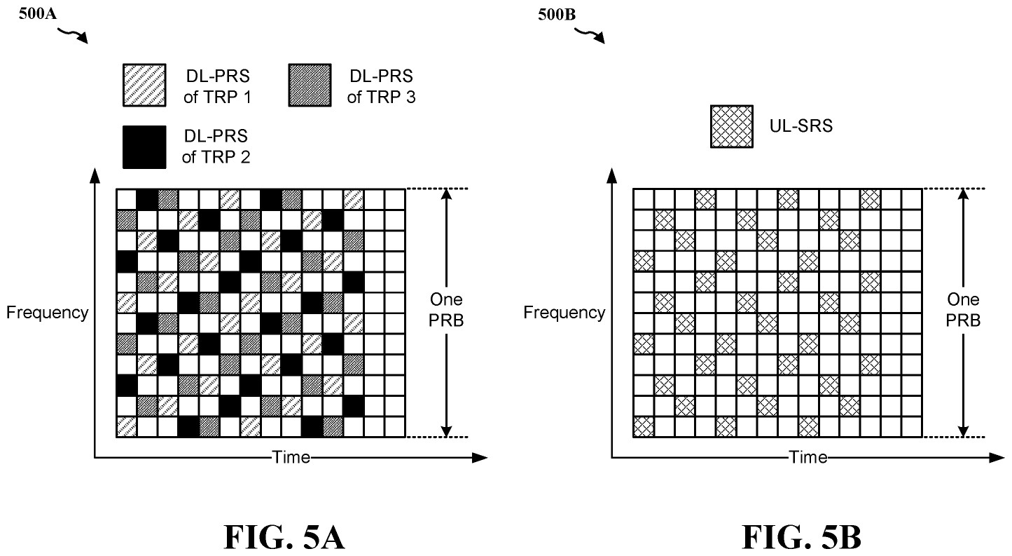

FIG. 5A is a diagram 500A illustrating an example of DL-PRS transmitted from multiple TRPs in accordance with various aspects of the present disclosure. In one example, a serving base station may configure DL-PRS to be transmitted from one or more TRPs within a slot or across multiple slots. If the DL-PRS is configured to be transmitted within a slot, the serving base station may configure the starting resource element in time and frequency from each of the one or more TRPs. If the DL-PRS is configured to be transmitted across multiple slots, the serving base station may configure gaps between DL-PRS slots, periodicity of the DL-PRS, and/or density of the DL-PRS within a period. The serving base station may also configure the DL-PRS to start at any physical resource block (PRB) in the system bandwidth. In one example, the system bandwidth may range from 24 to 276 PRBs in steps of 4 PRBs (e.g., 24, 28, 32, 36, etc.). The serving base station may transmit the DL-PRS in PRS beams, where a PRS beam may be referred to as a “PRS resource” and a full set of PRS beams transmitted from a TRP on a same frequency may be referred to as a “PRS resource set” or a “resource set of PRS,” such as described in connection with FIG. 4. As shown by FIG. 5A, the DL-PRS transmitted from different TRPs and/or from different PRS beams may be multiplexed across symbols or slots.

In some examples, each symbol of the DL-PRS may be configured with a comb-structure in frequency, where the DL-PRS from a TRP of a base station may occupy every N^{th} subcarrier. The comb value N may be configured to be 2, 4, 6, or 12. The length of the PRS within one slot may be a multiple of N symbols and the position of the first symbol within a slot may be flexible as long as the slot consists of at least N PRS symbols. The diagram 500A shows an example of a comb-6 DL-PRS configuration, where the pattern for the DL-PRS from different TRPs may be repeated after six (6) symbols.

FIG. 5B is a diagram 500B illustrating an example of UL-SRS transmitted from a UE in accordance with various aspects of the present disclosure. In one example, the UL-SRS from a UE may be configured with a comb-4 pattern, where the pattern for UL-SRS may be repeated after four (4) symbols. Similarly, the UL-SRS may be configured in an SRS resource of an SRS resource set, where each SRS resource may correspond to an SRS beam, and the SRS resource sets may correspond to a collection of SRS resources (e.g., beams) configured for a TRP. In some examples, the SRS resources may span 1, 2, 4, 8, or 12 consecutive OFDM symbols. In other examples, the comb size for the UL-SRS may be configured to be 2, 4, or 8.

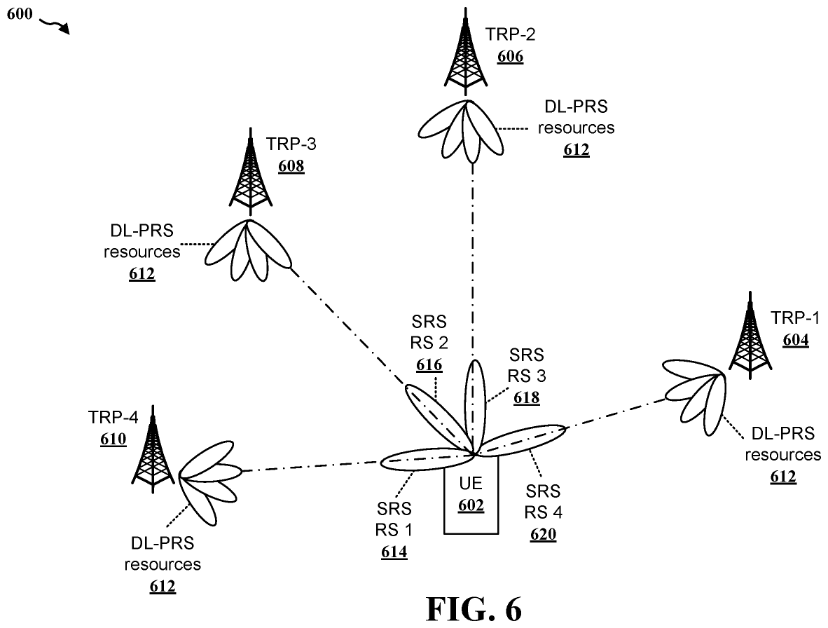

FIG. 6 is a diagram 600 illustrating an example of estimating a position of a UE based on multi-RTT measurements from multiple TRPs in accordance with various aspects of the present disclosure. A UE 602 may be configured by a serving base station to decode DL-PRS resources 612 that correspond to and are transmitted from a first TRP 604 (TRP-1), a second TRP 606 (TRP-2), a third TRP 608 (TRP-3), and a fourth TRP 610 (TRP-4). The UE 602 may also be configured to transmit UL-SRSs on a set of UL-SRS resources, which may include a first SRS resource 614, a second SRS resource 616, a third SRS resource 618, and a fourth SRS resource 620, such that the serving cell(s), e.g., the first TRP 604, the second TRP 606, the third TRP 608, and the fourth TRP 610, and as well as other neighbor cell(s), may be able to measure the set of the UL-SRS resources transmitted from the UE 602. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

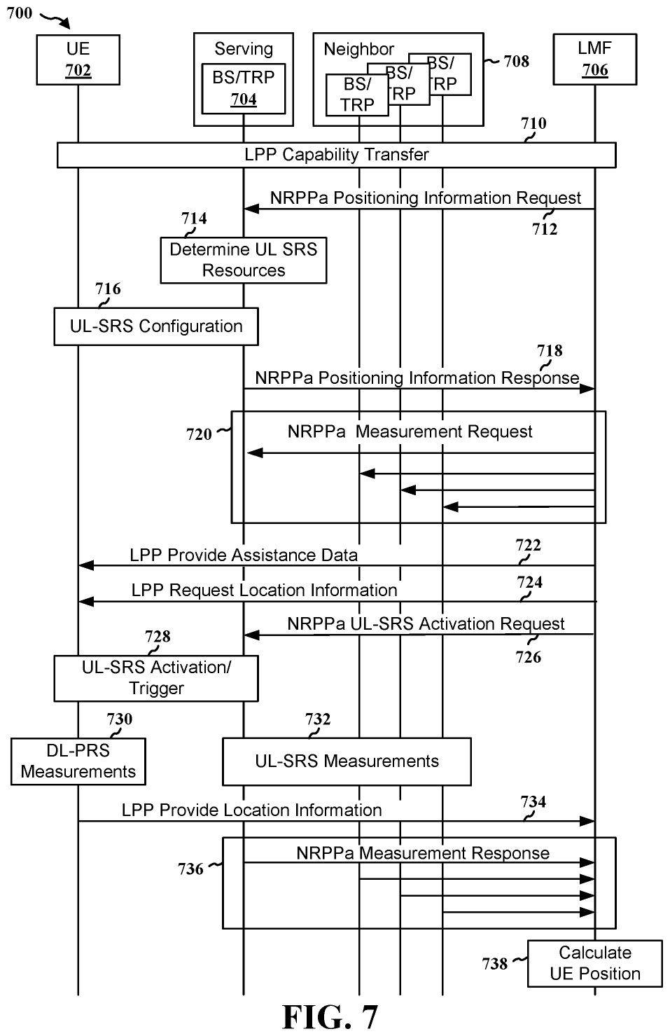

FIG. 7 is a communication flow 700 illustrating an example multi-RTT positioning procedure in accordance with various aspects of the present disclosure. The numberings associated with the communication flow 700 do not specify a particular temporal order and are merely used as references for the communication flow 700. In addition, a DL-only and/or an UL-only positioning may use a subset or subsets of this multi-RTT positioning procedure.

At 710, an LMF 706 may request one or more positioning capabilities from a UE 702 (e.g., from a target device). In some examples, the request for the one or more positioning capabilities from the UE 702 may be associated with an LTE Positioning Protocol (LPP). For example, the LMF 706 may request the positioning capabilities of the UE 702 using an LPP capability transfer procedure.

At 712, the LMF 706 may request UL SRS configuration information for the UE 702. The LMF 706 may also provide assistance data specified by a serving base station 704 (e.g., pathloss reference, spatial relation, and/or SSB configuration(s), etc.). For example, the LMF 706 may send an NR Positioning Protocol A (NRPPa) positioning information request message to the serving base station 704 to request UL information for the UE 702.

At 714, the serving base station 704 may determine resources available for UL SRS, and at 716, the serving base station 704 may configure the UE 702 with one or more UL SRS resource sets based on the available resources.

At 718, the serving base station 704 may provide UL SRS configuration information to the LMF 706, such as via an NRPPa positioning information response message.

At 720, the LMF 706 may select one or more candidate neighbor BSs/TRPs 708, and the LMF 706 may provide an UL SRS configuration to the one or more candidate neighbor BSs/TRPs 708 and/or the serving base station 704, such as via an NRPPa measurement request message. The message may include information for enabling the one or more candidate neighbor BSs/TRPs 708 and/or the serving base station to perform the UL measurements.

At 722, the LMF 706 may send an LPP provide assistance data message to the UE 702. The message may include specified assistance data for the UE 702 to perform the DL measurements.

At 724, the LMF 706 may send an LPP request location information message to the UE 702 to request multi-RTT measurements.

At 726, for semi-persistent or aperiodic UL SRS, the LMF 706 may request the serving base station 704 to activate/trigger the UL SRS in the UE 702. For example, the LMF 706 may request activation of UE SRS transmission by sending an NRPPa positioning activation request message to the serving base station 704.

At 728, the serving base station 704 may activate the UE SRS transmission and send an NRPPa positioning activation response message. In response, the UE 702 may begin the UL-SRS transmission according to the time domain behavior of UL SRS resource configuration.

At 730, the UE 702 may perform the DL measurements from the one or more candidate neighbor BSs/TRPs 708 and/or the serving base station 704 provided in the assistance data. At 732, each of the configured one or more candidate neighbor BSs/TRPs 708 and/or the serving base station 704 may perform the UL measurements.

At 734, the UE 702 may report the DL measurements to the LMF 706, such as via an LPP provide location information message.

At 736, each of the one or more candidate neighbor BSs/TRPs 708 and/or the serving base station 704 may report the UL measurements to the LMF 706, such as via an NRPPa measurement response message.

At 738, the LMF 706 may determine the RTTs from the UE 702 and BS/TRP Rx-Tx time difference measurements for each of the one or more candidate neighbor BSs/TRPs 708 and/or the serving base station 704 for which corresponding UL and DL measurements were provided at 734 and 736, and the LMF 706 may calculate the position of the UE 702.

In some scenarios, reference signals (e.g., PRS and SRS) and physical channels associated with UE positioning may be configured to be on-demand transmissions and receptions to improve network energy savings, resource utilization, and/or latency positioning latency. For example, a UE may be configured with a set of periodic PRS resources for a UE positioning session. However, periodic PRS scheduling may consume resources from data scheduling, thereby reducing available resources for data scheduling. On the other hand, if the UE positioning session is configured with on-demand transmission and/or reception, a UE may request the PRS to be transmitted based on the situation, which may reduce a number of PRSs transmitted from a TRP. In some examples, the on-demand transmission and reception may also enable a UE to request a burst of PRS to be transmitted between broadcasted PRS, which may improve positioning latency for UE positioning. The on-demand configuration may also enable a UE to skip monitoring for PRS at all time, which may help conserve network resources and UE power. For purposes of the present disclosure, the term “on-demand” may refer to a configuration that is triggered based on a request or an event. For example, an on-demand DL-PRS transmission may refer to a configuration that enables a UE or an LMF to request DL-PRS to be transmitted to the UE based on demands, where the request may further include a specific period for the DL-PRS transmission, a starting transmission time for the DL-PRS transmission, and/or an ending transmission time for the DL-PRS transmission, etc. In addition, such configuration may be initiated by the UE and/or the LMF. For example, on-demand transmission and reception of DL-PRS for DL and DL+UL positioning may be configured for UE-based positioning and UE-assisted positioning, which may include UE-initiated request of on-demand DL-PRS transmission and LMF (network)-initiated request of on-demand DL-PRS transmission, etc.

In some examples, a UE in an RRC inactive state (e.g., RRC_INACTIVE) or an idle state may be configured to support UE positioning, which may include UE-based positioning and UE-assisted positioning. For example, DL-PRS positioning methods and RAT-independent positioning methods may specify or configure a UE to measure PRS while the UE is in an RRC inactive state, and also to report positioning measurement or location estimate performed in the RRC inactive state when the UE is in the RRC inactive state.

In certain wireless communication systems, when a UE is in a connected state, the UE may be configured to maintain one or more tracking loops, such as a frequency tracking loop (FTL) or a time tracking time loop (TTL), through the utilization of periodic tracking reference signals (TRSs) configured by a base station in DL transmissions. For example, the UE may use the TRS, which may be transmitted from a base station periodically, to achieve or maintain timing and frequency tracking to maintain synchronization with incoming signals. When a UE is in an inactive mode or in an idle mode, the TRS may be continuously used by the UE for tracking loop updates. However, in some examples, the TRS may be configured for a UE while the UE is in a connected mode, but the TRSs may not be configured for the UE if the UE is in an idle/inactive mode. In other words, there may be no dedicated idle/inactive TRS that can be configured for a UE in an idle/inactive mode, such that there may be no extra network consumption while the UE is in the idle/inactive mode.

In some scenarios, when the density of TRS/synchronization signal block (SSB) increases (e.g., the periodicity of TRS/SSB decreases), a UE may be able to gain a better power saving as the UE may have more opportunities for performing tracking loop updates based on SSB and/or TRS. For example, if TRS with 20 ms periodicity is configured for a UE, on average the joint SSB/TRS periodicity may be 10 ms. With such a short TRS periodicity, it may be easier for the UE to find TRS when the UE wakes up from an idle/inactive mode. As such, the UE may be configured with a longer/deeper sleep time. In some examples, the configuration for TRS/CSI-RS occasion(s) may be provided to a UE via system information block (SIB) signaling, and the configuration may support just periodic TRS. For example, a base station may use Layer-1 (L1) singling to indicate to a UE whether a TRS is transmitted in one or more configured occasions by paging PDCCH. However, before the UE receives the indication, the UE may be configured to assume that there is no TRS transmission, such that the UE is not specified to perform blind detection for the TRS. In another example, the TRS may be quasi-co-located (QCL'ed) with a transmitted SSB, and subcarrier spacing (SCS) of TRS may be the same as SCS of control resources set zero (CORESET #0). In addition, a UE may be expected not to receive TRS outside of an initial DL bandwidth part (BWP).

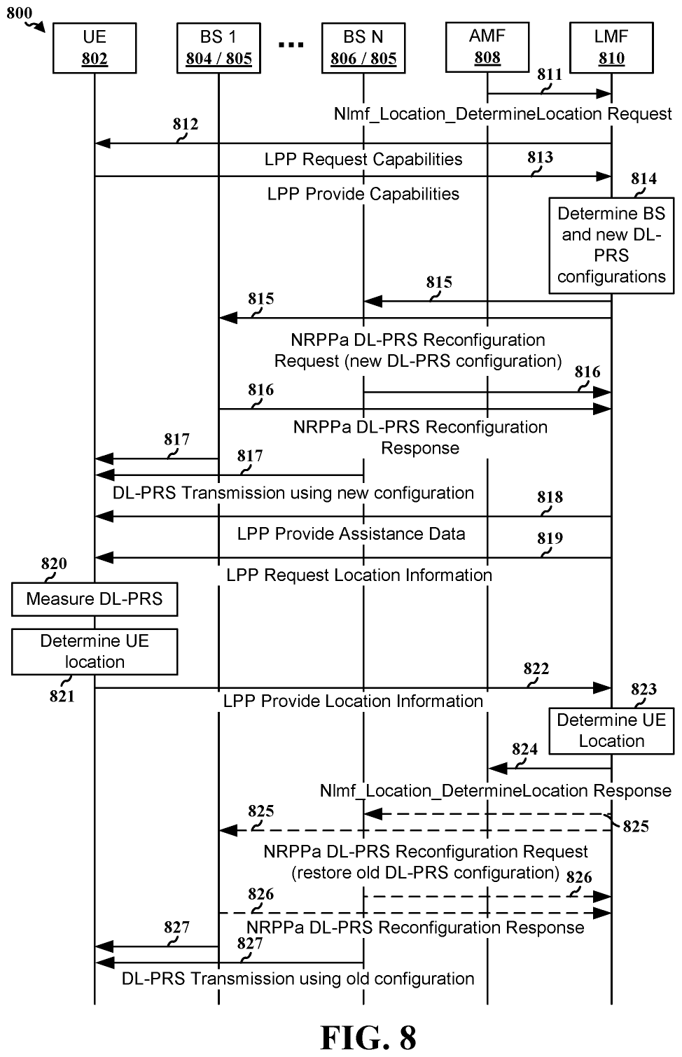

FIG. 8 is a communication flow 800 illustrating an example on-demand DL-PRS procedure in accordance with various aspects of the present disclosure. The on-demand DL-PRS procedure presented herein may be used for assisting DL positioning of UEs based on OTDOA, ECID, AoA, RTT, and/or AoD, etc., which may be controlled by an LMF 810. In addition, the on-demand DL-PRS transmission may be based on a UE-initiated request or an LMF (network)-initiated request. The LMF 810 may determine changes to PRS transmission and send a message (e.g., an NRPPa message) to affected base stations, which may include a first base station 804 and up to an N^{th} base station 806 (collectively as base stations 805), to request a change to PRS transmission. For example, the LMF 810 may determine the changes based on QoS specifications for location requests and on the capabilities of target UEs (e.g., UE 802) and the base stations 805 (e.g., if base station capabilities are configured in the LMF 810) to support increased or on-demand PRS transmission. The LMF 810 may control PRS transmission from the base stations 805 and/or from transmission points (TPs) and/or transmission and reception points (TRPs) within the base stations 805. Thus, one or more of the base stations 805 in FIG. 8 may each be replaced by a TP or a TRP.

At 811, (e.g., in response to receiving a location request for a UE 802 from another entity), a serving AMF 808 for the UE 802 may invoke an Nlmf_Location_DetermineLocation service operation towards the LMF 810 to request the current location of the UE 802. The service operation may include the serving cell identity, the location service (LCS) client type, and may also include a specified Quality of Service (QOS).

At 812, the LMF 810 may send an LPP Request Capabilities message to the UE 802 to request the positioning capabilities of the UE 802.

At 813, the UE 802 may return an LPP Provide Capabilities message to the LMF 810 to provide the positioning capabilities of the UE 802. The positioning capabilities may include the DL-PRS measurement capabilities of the UE 802.

At 814, based on the LCS client type (e.g., an emergency services client type or a commercial client type), the QoS if provided at 811, the DL-PRS measurement capabilities of the UE 802, and/or the capabilities of the base stations 805 to support increased or on-demand transmission of PRS (e.g., which may be configured in the LMF 810 or requested by the LMF 810 from each of the base stations 805), the LMF 810 may determine the base stations 805 nearby to the location of the UE 802 (e.g., as indicated by the serving cell ID received at 811) to be measured by the UE 802 and a PRS configuration or a new PRS configuration for each of the base stations 805. The LMF 810 may determine a new PRS configuration for one or more of the base stations 805 if the LMF 810 is aware of (e.g., is configured with) a normal default “old” PRS configuration for the one or more of the base stations 805 and may determine that a change in PRS transmission from the one or more of the base stations 805 is specified. The LMF 810 may also determine a PRS configuration for one or more of the base stations 805 if the LMF 810 is not aware of (e.g., is not configured with) a normal default “old” PRS configuration for the one or more of the base stations 805 and determines that a particular level of PRS transmission from one or more of the base stations 805 is specified. In either case, the PRS configuration that is determined for the one or more of the base stations 805 may be referred to as a “new PRS configuration.” The new PRS configuration for the base stations 805 may include a different PRS bandwidth, a different duration of PRS positioning occasions, and/or different PRS transmission frequencies, etc.

At 815, the LMF 810 may send an NRPPa PRS Reconfiguration Request message to each of the base stations 805 determined at 814 and includes the new PRS configuration determined for each of the base stations 805. The request may also include a start time for each new PRS configuration and/or a duration.

At 816, each of the base stations 805 may return a response to the LMF 810 indicating whether the new PRS configuration may be supported (or is now being transmitted). If some of the base stations 805 indicate that a new PRS configuration may not be supported, the LMF 810 may restore the old PRS configurations for these base stations (e.g., at 825 and 826) in order to avoid interference between base stations that support the new PRS configuration and base stations that do not. In this case, the LMF 810 may provide the old PRS configurations to the UE 802 at 818 instead of the new PRS configurations. In one example, if a base station is not able to support the requested new PRS configuration, the base station may provide a list of possible alternative PRS configurations in the response at 816 or may switch to transmitting some other new PRS configuration that supports different PRS transmission and indicate this new PRS configuration at 816. The LMF 810 may then reconsider some or all of the base stations with different new PRS configurations.

At 817, each of the base stations 805 that has acknowledged support of the new PRS configuration at 816 may change from an old PRS configuration to a new PRS configuration either after (or just before) sending the acknowledgment at 816 if no start time was provided or at the start time indicated at 815. In some cases, the old PRS configuration may correspond to not transmitting a DL-PRS.

At 818, the LMF 810 may send an LPP Provide Assistance Data message to the UE 802 to provide the new PRS configurations determined at 814 and acknowledged at 816 and also other assistance data to assist the UE 802 to acquire and measure the new PRS configurations and/or determine a location from the PRS measurements.

At 819, the LMF 810 may send an LPP Request Location Information message to the UE 802 to request the UE 802 to measure DL-PRS transmission from base stations 805 determined at 814 (and confirmed at 816) according to the new PRS configurations. For example, the LMF 810 may request measurements of RSTD if OTDOA is used, Rx-Tx if RTT is used and/or RSRP if AoD is used. The LMF 810 may also indicate whether UE-based positioning is requested whereby the UE 802 determines its own location. In some configurations, the LMF 810 may also include in the LPP Request Location Information message a request for location measurements for other position methods which do not use PRS (e.g., WiFi positioning or A-GNSS positioning).

At 820, the UE 802 may receive and measure the DL-PRS transmitted by the base stations 805 based on the new PRS configurations. For example, the UE 802 may obtain RSTD measurements when OTDOA is used, ToA or Rx-Rx measurements when RTT is used, or AoA or RSRP measurements when AoA or AoD is used. The UE 802 may also obtain other non-PRS measurements in addition if requested at 819.

At 821, if the UE-based positioning was specified at 819, the UE 802 may determine its location based on the PRS measurements (and any other measurements) obtained at 820 and the assistance data received at 818.

At 822, the UE 802 may send an LPP Provide Location Information message to the LMF 810 and includes the PRS measurements (and any other measurements) obtained at 820 or the UE location obtained at 821.

At 823, the LMF 810 may determine the UE 802's location based on any PRS measurements (and any other measurements) received at 822 or may verify the UE 802's location received at 822.

At 824, the LMF 810 may return an Nlmf_Location_DetermineLocation Response to the AMF 808 to indicate the location obtained at 823. The AMF 808 may then forward the location to another entity.

At 825, if a duration was not specified at 815, the LMF 810 may send an NRPPa PRS Reconfiguration Request message to the base stations 805 and include a request to restore the old PRS configuration for the base stations 805.

At 826, each of the base stations 805 may return a response to the LMF 810 indicating whether the old PRS configuration may be restored.

At 827, each of the base stations 805 may start transmitting PRS based on the old PRS configuration either when the duration received at 815 expires or after receiving and acknowledging the request to restore the old PRS configuration at 825 and 826.

Aspects presented herein may improve power efficiency and latency for UE positioning. Aspects presented herein may enable a UE to utilize other types of reference signals, such as reference signals configured for communications, for positioning measurements, such that power consumption at both the UE and the network (e.g., base station, location server, etc.) may be reduced during a UE positioning session.

In one aspect of the present disclosure, wideband reference signal (RS) not associated with positioning (e.g., RS for non-positioning purposes) may be leveraged by the UE and other positioning entities for positioning purpose. In other words, one or more base stations may be configured to formulate RS for non-positioning purposes into PRS for UE positioning. For example, the TRS may be a good option of being leveraged by the UE for positioning measurements because of TRS' natural good support for timing measurement (e.g., for tracking loop updates). The feature of enabling/configuring a UE to measure TRS in an idle/inactive mode may further make TRS suitable for network/device efficient positioning. In some examples, due to potential congestion between communication service and positioning service, a serving base station may not always (at least in some periods) have the capability to schedule all or sufficient PRSs demanded/requested by an LMF or a UE. As such, if one or more communication RSs may be reused for positioning measurement, power and resource consumptions at both the UE and the base station (or TRPs associated with the base station) may be reduced. As the modem (or the processor) of a UE may be configured to process some communication RSs, the UE may use such opportunity to also use the processed communication RSs for positioning. By reusing the communication RS, the positioning latency may also be improved as a UE positioning session may not exclusively be based on PRS availabilities/configurations. In other words, the LMF may not wait for a long time for the PRS availability. For purposes of the present disclosure, an RS that is (originally) configured for communication may be referred to as a “DL-RS” or a “communication RS,” whereas an RS that is configured for positioning may be referred to as a “DL-PRS,” a “PRS,” or an “RS for positioning.” For example, a TRS may be a DL-RS or a communication RS.

In another aspect of the present disclosure, the on-demand DL-PRS procedure described in connection with FIG. 8 is further optimized/improved into an on-demand RS procedure to support different types of DL-RS for positioning purposes/procedures. The improved on-demand RS procedure presented herein may enable a network and/or a UE to treat any types of DL-RS as DL-PRS, where the actual RS type may be configured to be transparent to the UE. However, in some scenarios, such configuration may specify the DL-RS to be scheduled by one or more base stations (or TRPs of a base station) based on the demand from LMF/UE for positioning purpose. As other DL-RS may primarily be used for communication purposes, some base stations may put LMF/UE's on-demand PRS/RS request (e.g., to formulate DL-RS as DL-PRS resource pattern) as low priority, and some base stations may not have the capability to formulate DL-RS as DL-PRS. As such, in another aspect of the present disclosure, a base station's capability and/or availability to formulate a specific DL-PRS based on other DL-RS (such as TRS) may be reported to an LMF for the LMF's base station selection and/or PRS allocation.

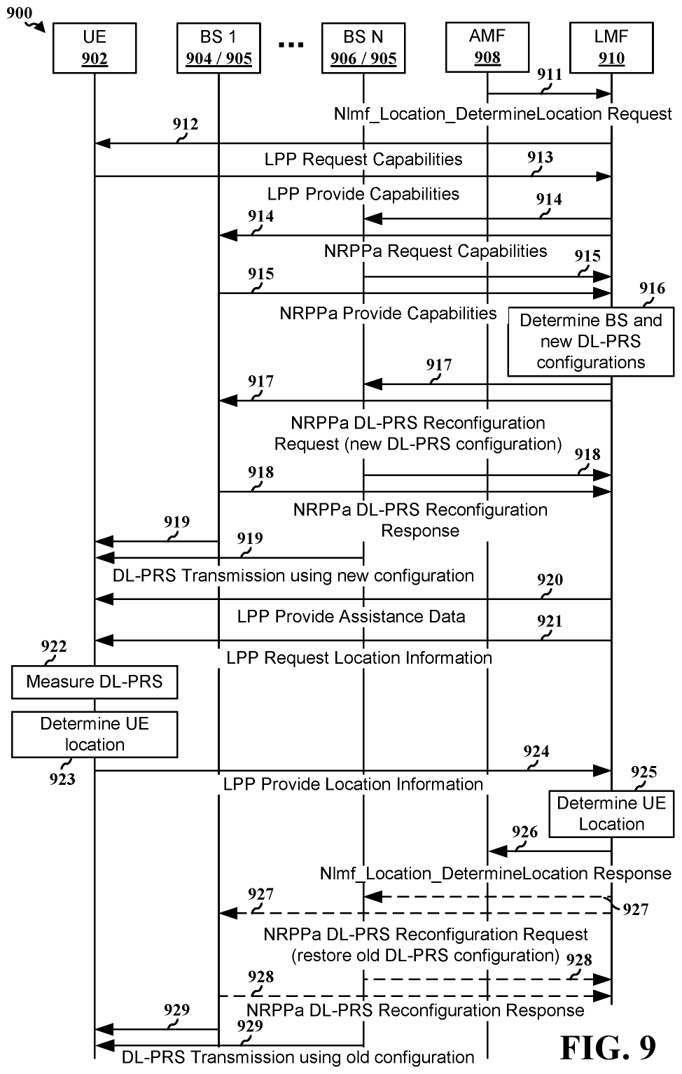

FIG. 9 is a communication flow 900 illustrating an example of an on-demand DL-PRS/DL-RS procedure based on reusing TRS for network/device efficient UE positioning in accordance with various aspects of the present disclosure. The on-demand DL-PRS/DL-RS procedure presented herein may be used for assisting DL positioning of UEs based on OTDOA, ECID, AoA, RTT, and/or AoD, etc., which may be controlled by a network entity or a positioning server associated with UE positioning, such as an LMF 910. In addition, the on-demand DL-PRS transmission may be based on UE-initiated request or LMF (network)-initiated request. The LMF 910 may determine changes to PRS transmission/configuration and send a message (e.g., an NRPPa message) to affected base stations, which may include a first base station 904 and up to an N^{th} base station 906 (collectively as the base stations 905), to request a change to PRS transmission/configuration. For example, the LMF 910 may determine the changes based on QoS specifications for location requests and on the capabilities of target UEs (e.g., the UE 902) and the base stations 905 (e.g., if base station capabilities are configured in the LMF 910) to support increased or on-demand DL-PRS/DL-RS transmission. The LMF 910 may control PRS transmission from the base stations 905 and/or from TPs and/or TRPs within the base stations 905. Thus, for purposes of the present disclosure, one or more of the base stations 905 in FIG. 9 may each be replaced by a TP or a TRP. Also, the on-demand DL-PRS/DL-RS procedure presented herein may apply when the UE 902 is in an idle/inactive mode.

At 911, (e.g., in response to receiving a location request for a UE 902 from another entity), a serving AMF 908 for the UE 902 may invoke an Nlmf_Location_DetermineLocation service operation towards the LMF 910 to request the current location of the UE 902. The service operation may include the serving cell identity, the LCS client type, and may also include a specified QoS.

At 912, the LMF 910 may send an LPP Request Capabilities message to the UE 902 to request the positioning capabilities of the UE 902.

At 913, in response to the LPP Request Capabilities message, the UE 902 may return an LPP Provide Capabilities message to the LMF 910 to provide the positioning capabilities of the UE 902. The positioning capabilities may include the DL-PRS measurement capabilities of the UE 902.

At 914, the LMF 910 may send a capability request message (e.g., an NRPPa Request Capabilities message) to the base stations 905 to request reporting of the capability on supporting transmitting the TRS (or other DL-RS) as the DL-PRS transmission (e.g., for positioning purposes). In other words, the capability request message may request each of the base stations 905 to indicate whether it has the capability to formulate DL-RS into DL-PRS.

At 915, in response to the LMF 910's capability request message, each of the base stations 905 may report a group of capabilities on supporting transmitting the TRS as the DL-PRS transmission (e.g., for positioning purposes), such as via a capability report message (e.g., an NRPPa Provide Capabilities message).

In one example, the capability report may include whether the base station supports formulating DL-PRS based on TRS. In another example, to improve efficiency of signaling between a base station and the LMF 910, if a base station indicates that it does not support the capability to formulate DL-PRS based on TRS, then the base station may be configured to skip signaling other capabilities. In other words, if the capability to formulate DL-PRS based on TRS is no, other capabilities may not be signaled.

In another example, the capability report may include the type of TRS or DL-RS supported by a base station. For example, the capability report may indicate that the base station supports aperiodic-TRS (AP-TRS), semi-persistence-TRS (SP-TRS) (which may also be referred to as semi-periodic-TRS), and/or periodic-TRS (P-TRS). In addition, if a base station indicates that it has the capability to support SP-TRS and/or P-TRS, the base station may further indicate the supported periodicity for the SP-TRS and/or P-TRS (e.g., P-TRS periodicity=10 ms, 20 ms, etc.).

In another example, the capability report may include whether a base station has the capability to configure TRS for a UE in an idle mode/inactive mode. For example, the base station may indicate that it has the capability to configure TRS for the UE 902 in an inactive mode.

In another example, the capability report may include a maximum supported bandwidth (BW) for TRS transmission(s). For example, the base station may indicate that it supports up to 10 MHz BW for TRS transmission(s).

In another example, the capability report may include the duration of TRS transmission that may also serve as PRS transmission. For example, multiple base stations may have the capability to formulate TRS into PRS. However, due to different base stations may have different resource availabilities, where some base stations may have more resources to support a longer duration of transmitting/formulating TRS as PRS than others, each of the base station may report a duration or a time window in which TRS transmission(s) may also serve as PRS transmission(s).

In another example, the capability report may include whether a base station has the capability to formulate the TRS to a specific DL-PRS resource pattern or a DL-PRS resource pattern that is compatible with or supported by a different or an older network communication system (e.g., such as formulating the TRS to a legacy DL-PRS resource pattern). In addition, if a base station indicates that it has the capability to formulate the TRS to a specific DL-PRS resource pattern, the base station may further indicate in the capability report the PRS comb pattern that may be formulated based on TRS (e.g., as described in connection with FIGS. 5A and 5B), and/or the frequency domain (FD) comb pattern and the number of symbols for each PRS resource, etc. On the other hand, in some examples, if the base station indicates that it does not have the capability to formulate the TRS to a specific DL-PRS resource pattern, the base station may report TRS configurations or DL-PRS patterns supported by the base station. For example, the base station may report the DL-PRS comb patterns that may be formulated by the base station based on TRS to the LMF 910.

In another example, the capability report may include whether a base station support TRS muting (e.g., transmitting one or more TRSs with zero-power for a specified time and/or frequency resource). For example, after a base station (or TRP of the base station) is scheduled to transmit on a set of PRS resources, the base station may determine to mute some of the PRS transmissions, such as for purposes of reducing interference and/or for power consumption, etc. If a PRS resource is being muted, the base station may transmit a PRS based on the PRS resource with zero-power. For example, if PRSs transmitted from a serving base station have a stronger signal strength than PRSs transmitted from a neighbor base station (from a UE's perspective), then the serving base station may determine to mute some of its PRS transmissions, such that PRSs transmitted from the neighbor base station may be more easily detected by the UE. As such, a base station may report whether it supports PRS muting in the capability report.

At 916, based at least in part on the capability reports received from the base stations 905, the LMF 910 may determine which of the base stations 905 may be used for the UE positioning session and the DL-PRS configurations (e.g., formulation of DL-PRS based on TRS). In other words, after getting the TRS related capabilities from the base stations 905, the LMF 910 may determine the base stations for the on-demand DL-PRS/DL-RS request. For example, the LMF 910 may select base stations that support specific PRS resource pattern(s) (e.g., PRS patterns that are compatible with a different or older version of the communication/positioning system), base stations that is capable of transmitting TRSs for positioning purposes (i.e., formulating TRS into PRS), base stations that support both specific PRS resource pattern(s) and formulating TRS to PRS, or a combination thereof.

In some examples, at 914, the LMF 910 may also transmit the capability request message to one or more base stations for UE positioning sessions that do not specify formulating DL-RS to DL-PRS. For example, is a UE positioning session is associated with an on-demand DL-PRS as described in connection with FIG. 8, the LMF 808/908 may still transmit the capability request message to the base stations 805/905 to request the base stations 805/905 to provide their PRS related capacities, such as capabilities to provide specific pattern of PRS. As such, the LMF 910 may be able to make a more informed decision regarding which base stations to select for the UE positioning session (e.g., for the PRS transmission), which may improve the network efficiency. In such an example, the capability report from the base stations 805/905 may be configured to be simpler compared to the capability report involving TRS capabilities. For example, the base stations 805/905 may just be specified to report its capability to support PRS transmission with one or more on-demand properties, such as the PRS resource pattern, the type of beam for transmitting PRS, and/or the periodicity of PRS, etc.

At 916, as described in connection with 814 of FIG. 8, in determining which base stations and/or DL-PRS configurations to use for the UE positioning session (e.g., for transmitting PRS), the determination may further based at least in part on the LCS client type (e.g., an emergency services client type or a commercial client type), the QoS if provided at 911, the DL-PRS measurement capabilities of the UE 902, and/or the capabilities of the base stations 905 to support increased or on-demand transmission of PRS, etc. In some examples, the LMF 910 may determine a new PRS configuration for one or more of the base stations 905 if the LMF 910 is aware of (e.g., is configured with) a normal default “old” PRS configuration for the one or more of the base stations 905 and determines that a change in PRS transmission from the one or more of the base stations 905 is specified. The LMF 910 may also determine a PRS configuration for one or more of the base stations 905 if the LMF 910 is not aware of (e.g., is not configured with) a normal default “old” PRS configuration for the one or more of the base stations 905 and determines that a particular level of PRS transmission from one or more of the base stations 905 is specified. In either case, the PRS configuration that is determined for the one or more of the base stations 905 may be referred to as a “new PRS configuration.” The new PRS configuration for the base stations 905 may include a different PRS bandwidth, a different duration of PRS positioning occasions, and/or different PRS transmission frequencies, etc.

At 917, the LMF 910 may send a PRS reconfiguration request message (e.g., an NRPPa PRS Reconfiguration Request message) to each of the base stations determined at 916 and includes the new PRS configuration determined for each of the base stations determined at 916. The request may also include a start time for each new PRS configuration and/or a duration associated with the new PRS configuration. For example, the LMF 910 may explicitly request the on-demand PRS to be formulated based on specific PRS patterns (e.g., legacy PRS patterns) or based on TRS as the on-demand PRS formulated based on TRS may not be with the same pattern as the specific PRS patterns. In other examples, if specific PRS patterns are not supported by some of the base stations 905, the LMF 910 may on-demand request/configure some other PRS patterns (e.g., non-legacy PRS pattern) that may be formulated based on TRS to enhance the network/device efficiency and to reduce the positioning latency. For example, the LMF 910 may request a PRS pattern that may be formulated from TRS by all of the base stations 905 or by base stations that are participating in the UE positioning session.

At 918, each of the base stations 905 may return a response to the LMF 910 indicating whether the new PRS configuration (e.g., PRS formulated based on TRS) may be supported (or is now being transmitted). If some of the base stations 905 indicate that a new PRS configuration may not be supported, the LMF 910 may restore the old PRS configurations for these base stations (e.g., at 927 and 928) in order to avoid interference between base stations that support the new PRS configuration and base stations that do not. In this case, the LMF 910 may provide the old PRS configurations to the UE 902 at 920 instead of the new PRS configurations. In one example, if a base station is not able to support the requested new PRS configuration, the base station may provide a list of possible alternative PRS configurations in the response at 918 or may switch to transmitting some other new PRS configuration that supports different PRS transmission and indicate this new PRS configuration at 918. The LMF 910 may then reconsider some or all of the base stations with different new PRS configurations.

At 919, each of the base stations 905 that has acknowledged support of the new PRS configuration at 918 may change from an old PRS configuration to a new PRS configuration either after (or just before) sending the acknowledgment at 918 if no start time was provided or at the start time indicated at 917. In some cases, the old PRS configuration may correspond to not transmitting a DL-PRS. Note that the UE 902 may receive the DL-PRS (which may be formulated based on TRS) while the UE is in an idle/inactive state.

At 920, the LMF 910 may send an LPP Provide Assistance Data message to the UE 902 to provide the new PRS configurations determined at 916 and acknowledged at 918 and also other assistance data to assist the UE 902 to acquire and measure the new PRS configurations and/or determine a location from the PRS measurements.

At 921, the LMF 910 may send an LPP Request Location Information message to the UE 902 to request the UE 902 to measure DL-PRS transmission from base stations determined at 916 (and confirmed at 918) according to the new PRS configurations (e.g., based on PRS formulated based on TRS). For example, the LMF 910 may request measurements of RSTD if OTDOA is used, Rx-Tx if RTT is used and/or RSRP if AoD is used. The LMF 910 may also indicate whether UE-based positioning is requested whereby the UE 902 determines its own location. In some configurations, the LMF 910 may also include in the LPP Request Location Information message a request for location measurements for other position methods which do not use PRS (e.g., WiFi positioning or A-GNSS positioning).

At 922, the UE 902 may receive and measure the DL-PRS transmitted by the base stations determined at 916 based on the new PRS configurations (e.g., based on PRS formulated from TRS). For example, the UE 902 may obtain RSTD measurements when OTDOA is used, ToA or Rx-Rx measurements when RTT is used, or AoA or RSRP measurements when AoA or AoD is used. The UE 902 may also obtain other non-PRS measurements in addition if requested at 921. The UE 902 may receive and measure the DL-PRS transmitted by the base stations determined at 916 while the UE 902 is in an idle/inactive mode.

At 923, if the UE-based positioning was specified at 921, the UE 902 may determine its location based on the PRS measurements (and any other measurements) obtained at 922 and the assistance data received at 920.

At 924, the UE 902 may send an LPP Provide Location Information message to the LMF 910 and includes the PRS measurements (and any other measurements) obtained at 922 or the UE location obtained at 923.

At 925, the LMF 910 may determine the UE 902's location based on any PRS measurements (and any other measurements) received at 924 or may verify the UE 902's location received at 924.

At 926, the LMF 910 may return an Nlmf_Location_DetermineLocation Response to the AMF 908 to indicate the location obtained at 925. The AMF 908 may then forward the location to another entity.

At 927, if a duration was not specified at 917, the LMF 910 may send an NRPPa PRS Reconfiguration Request message to the base stations 905 and include a request to restore the old PRS configuration for the base stations 905.

At 928, each of the base stations 905 may return a response to the LMF 910 indicating whether the old PRS configuration may be restored.

At 929, each of the base stations 905 may start transmitting PRS based on the old PRS configuration either when the duration received at 917 expires or after receiving and acknowledging the request to restore the old PRS configuration at 927 and 928.

In another aspect of the present disclosure, for DL-PRS formulated based on TRS, as the network (e.g., the LMF 910) may not be able to guarantee P-TRS transmissions when the UE 902 is in an idle/inactive mode, a layer-1 (L1) singling may be transmitted to the UE 902 to indicate whether TRS is going to be transmitted if the UE 902 is in the idle/inactive mode. As such, before the UE 902 receives the indication, the UE may determine/assume that no TRS is to be transmitted from the base stations 905 (e.g., no blind detection is specified for the UE 902). In other words, unless the UE 902 is informed about the TRS transmissions from one or more of the base stations 905 after the UE 902 enters into an idle/inactive mode, the UE does not monitor for TRS transmissions (or PRS formulated based on TRS) during the idle/inactive mode.

In one example, if the UE 902 and/or the LMF 910 on-demand request P-TRS for a UE positioning session and the network does not guarantee P-TRS transmission for the UE 902 in an idle/inactive mode, the network may indicate to the UE 902 regarding whether TRS (e.g., PRS formulated based on TRS) is transmitted via positioning system information block (SIB) to save UE 902's power, such that the 910 UE may skip monitoring for TRS if no indication is received. In addition, if the indication indicates that the P-TRS transmission in the idle/inactive mode has stopped, the UE 902 may also stop the corresponding PRS/TRS measurements. In other words, from the UE 902's perspective, it may be similar to stopping/skipping some measuring instances for a periodical PRS.

In another example, the base stations 905 may indicate to the LMF 910 whether they are able to transmit P-TRS to the UE 902 if the UE 902 is in an idle/inactive mode, such as via the capability report message at 915 or via a separate signaling. In response, the LMF 910 may select the base stations that support P-TRS transmission in idle/inactive mode for PRS transmission (e.g., PRS formulated based on TRS) when the UE 902 is in the idle/inactive mode. In such an example, the UE 902 may be configured to assume PRS (configured through P-TRS) is always transmitted without receiving notification from the network.

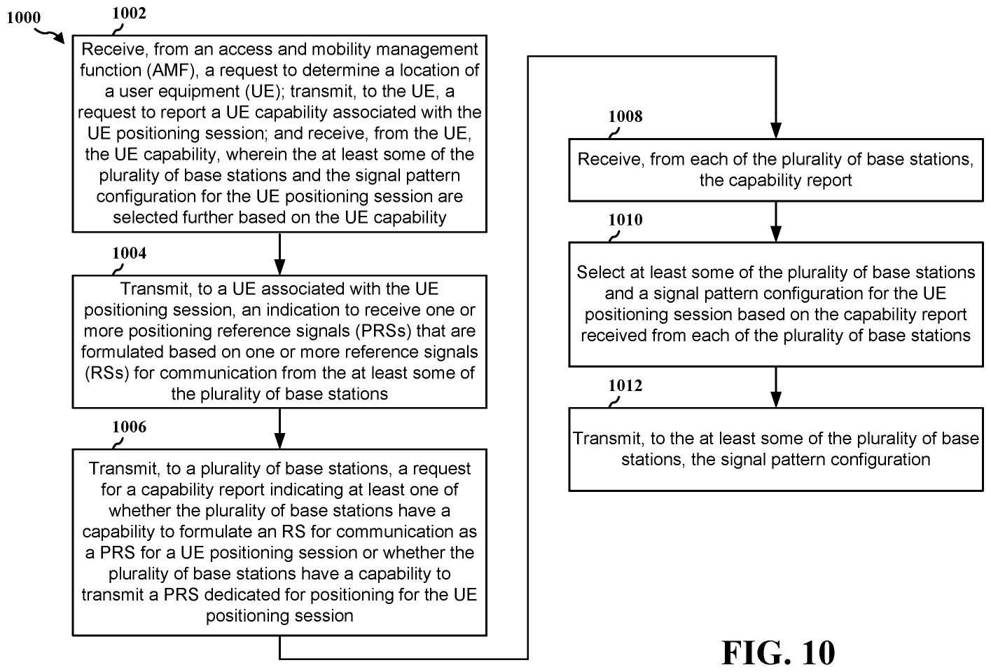

FIG. 10 is a flowchart 1000 of a method of wireless communication. The method may be performed by a network entity or a component of a network entity (e.g., the LMF 706, 810, 910; the apparatus 1202; a processing system, which may include the memory 376 and which may be the entire base station 310 or a component of the base station 310, such as the TX processor 316 the RX processor 370, and/or the controller/processor 375). The method may enable the network entity, such as an LMF or a network node associated with UE positioning, to configure other types of reference signals, such as reference signals configured for communications, for positioning measurements, such that power consumption at both the UE and the network (e.g., base station, location server, etc.) may be reduced during a UE positioning session.

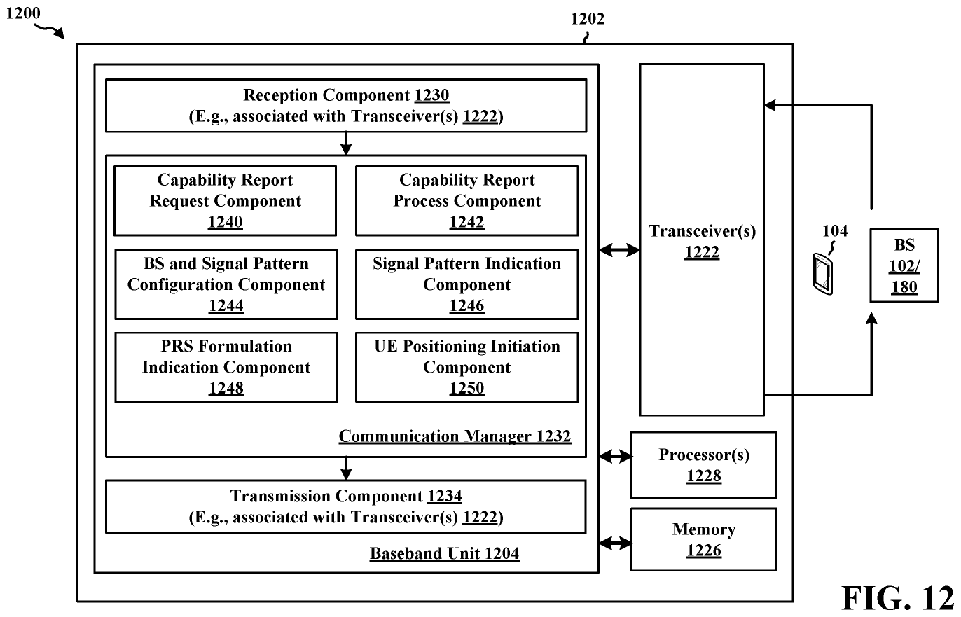

At 1002, the network entity may receive, from an AMF, a request to determine a location of a UE, the network entity may transmit, to the UE, a request to report a UE capability associated with the UE positioning session, and the network entity may receive, from the UE, the UE capability, where the at least some of the plurality of base stations and the signal pattern configuration for the UE positioning session are selected further based on the UE capability, such as described in connection with FIG. 9. For example, at 911, the LMF 910 (which is a network entity) may receive, from the AMF 908, a request to determine a location of a UE 902. At 912, the LMF 910 may transmit, to the UE 902, a request to report a UE capability associated with the UE positioning session. Then, 913, the LMF 910 may receive, from the UE 902, the UE capability, where the at least some of the plurality of base stations and the signal pattern configuration for the UE positioning session may be selected further based on the UE capability. The process of the UE positioning may be performed by, e.g., the UE positioning initiation component 1250, the reception component 1230, and/or the transmission component 1234 of the apparatus 1202 in FIG. 12.

At 1004, the network entity may transmit, to a UE associated with the UE positioning session, an indication to receive one or more PRSs that are formulated based on one or more RSs for communication from the at least some of the plurality of base stations, such as described in connection with FIG. 9. For example, at 912, the LMF 910 may transmit to the UE 902 an indication to receive one or more PRSs that are formulated based on one or more RSs for communication from the at least some of the plurality of base stations. The transmission of the indication may be performed by, e.g., the PRS formulation indication component 1248 and/or the transmission component 1234 of the apparatus 1202 in FIG. 12.

In one example, the one or more PRSs may be associated with periodic resources.

In another example, the indication may be transmitted via a positioning system information block.

At 1006, the network entity may transmit, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session, such as described in connection with FIG. 9. For example, at 914, the LMF 910 may transmit, to multiple base stations 905, a request for a capability report indicating at least one of whether the plurality of base stations have a capability to formulate an RS for communication as a PRS for a UE positioning session or whether the multiple base stations 905 have a capability to transmit a PRS dedicated for positioning for the UE positioning session. The transmission of the request for the capability report may be performed by, e.g., the capability report request component 1240 and/or the transmission component 1234 of the apparatus 1202 in FIG. 12.

In one example, the RS for communication may include a TRS.

At 1008, the network entity may receive, from each of the plurality of base stations, the capability report, such as described in connection with FIG. 9. For example, at 915 the LMF 910 may receive, from each of the multiple base stations 905, the capability report. The reception of the capability report may be performed by, e.g., the capability report process component 1242 and/or the reception component 1230 of the apparatus 1202 in FIG. 12.

In one example, if the capability report from a base station of the plurality of base stations indicates that the base station does not have the capability to formulate the RS for communication as the PRS, the network entity may exclude the base station from the at least some of the plurality of base stations for the UE positioning session.

In another example, if the capability report from a base station of the plurality of base stations indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting. In such an example, the at least one RS type includes one or more of: an AP-TRS, an SP-TRS, or a P-TRS.

In another example, if the capability report from a base station of the plurality of base stations indicates that the base station does not have the capability to formulate the RS for communication as the PRS but has the capability to transmit the PRS dedicated for positioning, the capability report further includes one or more of: a resource pattern associated with the PRS, a beam type associated with a transmission of the PRS, a periodicity associated with the PRS.

In another example, the network entity may receive, from the at least some of the plurality of base stations, an indication of whether one or more PRSs formulated based on one or more RSs for communication are transmitted to the UE from the at least some of the plurality of base stations during an idle mode or an inactive mode of the UE, and the network entity may select the at least some of the plurality of base stations for the UE positioning session based on the indication that the one or more PRSs are transmitted to the UE during the idle mode or the inactive mode of the UE.

At 1010, the network entity may select at least some of the plurality of base stations and a signal pattern configuration for the UE positioning session based on the capability report received from each of the plurality of base stations, such as described in connection with FIG. 9. For example, at 916, the LMF 910 may select at least some of multiple base stations 905 and a signal pattern configuration for the UE positioning session based on the capability report received from each of the multiple base stations 905. The selection of the base station and the signal pattern may be performed by, e.g., the BS and signal pattern configuration component 1244 of the apparatus 1202 in FIG. 12.

In one example, the signal pattern configuration may correspond to a first PRS pattern formulated based on the PRS dedicated for positioning or a second PRS pattern formulated based on the RS for communication that is different from the first PRS pattern. In such an example, the signal pattern configuration may be selected further based on whether the at least some of the plurality of base stations are able to transmit the first PRS pattern, or whether the at least some of the plurality of base stations are able to transmit both the first PRS pattern and the second PRS pattern.

At 1012, the network entity may transmit, to the at least some of the plurality of base stations, the signal pattern configuration, such as described in connection with FIG. 9. For example, at 917, the LMF 910 may transmit, to the at least some of the multiple base stations 905, the signal pattern configuration. The transmission of the signal pattern configuration may be performed by, e.g., the signal pattern indication component 1246 and/or the transmission component 1234 of the apparatus 1202 in FIG. 12.

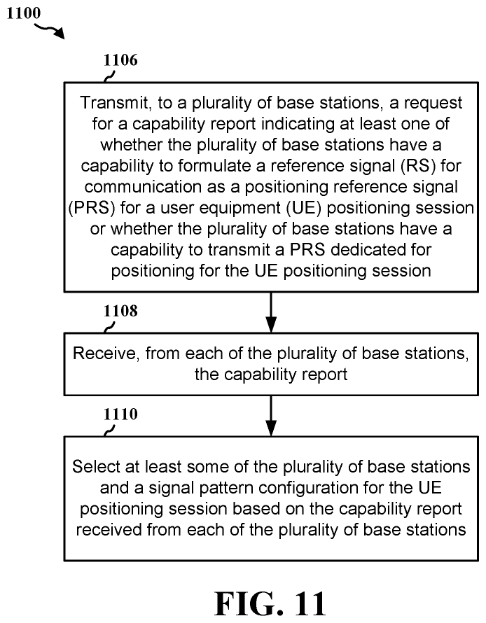

FIG. 11 is a flowchart 1100 of a method of wireless communication. The method may be performed by a network entity or a component of a network entity (e.g., the LMF 706, 810, 910; the apparatus 1202; a processing system, which may include the memory 376 and which may be the entire base station 310 or a component of the base station 310, such as the TX processor 316 the RX processor 370, and/or the controller/processor 375). The method may enable the network entity to configure other types of reference signals, such as reference signals configured for communications, for positioning measurements, such that power consumption at both the UE and the network (e.g., base station, location server, etc.) may be reduced during a UE positioning session.

At 1106, the network entity may transmit, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session, such as described in connection with FIG. 9. For example, at 914, the LMF 910 may transmit, to multiple base stations 905, a request for a capability report indicating at least one of whether the plurality of base stations have a capability to formulate an RS for communication as a PRS for a UE positioning session or whether the multiple base stations 905 have a capability to transmit a PRS dedicated for positioning for the UE positioning session. The transmission of the request for the capability report may be performed by, e.g., the capability report request component 1240 and/or the transmission component 1234 of the apparatus 1202 in FIG. 12.

In one example, the RS for communication may include a TRS.

In another example, the network entity may receive, from an AMF, a request to determine a location of a UE, the network entity may transmit, to the UE, a request to report a UE capability associated with the UE positioning session, and the network entity may receive, from the UE, the UE capability, where the at least some of the plurality of base stations and the signal pattern configuration for the UE positioning session are selected further based on the UE capability, such as described in connection with FIG. 9. For example, at 911, the LMF 910 may receive, from the AMF 908, a request to determine a location of a UE 902. At 912, the LMF 910 may transmit, to the UE 902, a request to report a UE capability associated with the UE positioning session. Then, 913, the LMF 910 may receive, from the UE 902, the UE capability, where the at least some of the plurality of base stations and the signal pattern configuration for the UE positioning session may be selected further based on the UE capability. The process of the UE positioning may be performed by, e.g., the UE positioning initiation component 1250, the reception component 1230, and/or the transmission component 1234 of the apparatus 1202 in FIG. 12.

In another example, the network entity may transmit, to a UE associated with the UE positioning session, an indication to receive one or more PRSs that are formulated based on one or more RSs for communication from the at least some of the plurality of base stations, such as described in connection with FIG. 9. For example, at 912, the LMF 910 may transmit to the UE 902 an indication to receive one or more PRSs that are formulated based on one or more RSs for communication from the at least some of the plurality of base stations. The transmission of the indication may be performed by, e.g., the PRS formulation indication component 1248 and/or the transmission component 1234 of the apparatus 1202 in FIG. 12. In such an example, the one or more PRSs may be associated with periodic resources. In such an example, the indication may be transmitted via a positioning system information block.

At 1108, the network entity may receive, from each of the plurality of base stations, the capability report, such as described in connection with FIG. 9. For example, at 915 the LMF 910 may receive, from each of the multiple base stations 905, the capability report. The reception of the capability report may be performed by, e.g., the capability report process component 1242 and/or the reception component 1230 of the apparatus 1202 in FIG. 12.

In one example, if the capability report from a base station of the plurality of base stations indicates that the base station does not have the capability to formulate the RS for communication as the PRS, the network entity may exclude the base station from the at least some of the plurality of base stations for the UE positioning session.

In another example, if the capability report from a base station of the plurality of base stations indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting. In such an example, the at least one RS type includes one or more of: an AP-TRS, an SP-TRS, or a P-TRS.

In another example, if the capability report from a base station of the plurality of base stations indicates that the base station does not have the capability to formulate the RS for communication as the PRS but has the capability to transmit the PRS dedicated for positioning, the capability report further includes one or more of: a resource pattern associated with the PRS, a beam type associated with a transmission of the PRS, a periodicity associated with the PRS.

In another example, the network entity may receive, from the at least some of the plurality of base stations, an indication of whether one or more PRSs formulated based on one or more RSs for communication are transmitted to the UE from the at least some of the plurality of base stations during an idle mode or an inactive mode of the UE, and the network entity may select the at least some of the plurality of base stations for the UE positioning session based on the indication that the one or more PRSs are transmitted to the UE during the idle mode or the inactive mode of the UE.

At 1110, the network entity may select at least some of the plurality of base stations and a signal pattern configuration for the UE positioning session based on the capability report received from each of the plurality of base stations, such as described in connection with FIG. 9. For example, at 916, the LMF 910 may select at least some of multiple base stations 905 and a signal pattern configuration for the UE positioning session based on the capability report received from each of the multiple base stations 905. The selection of the base station and the signal pattern may be performed by, e.g., the BS and signal pattern configuration component 1244 of the apparatus 1202 in FIG. 12.

In one example, the signal pattern configuration may correspond to a first PRS pattern formulated based on the PRS dedicated for positioning or a second PRS pattern formulated based on the RS for communication that is different from the first PRS pattern. In such an example, the signal pattern configuration may be selected further based on whether the at least some of the plurality of base stations are able to transmit the first PRS pattern, or whether the at least some of the plurality of base stations are able to transmit both the first PRS pattern and the second PRS pattern.

In another example, the network entity may transmit, to the at least some of the plurality of base stations, the signal pattern configuration, such as described in connection with FIG. 9. For example, at 917, the LMF 910 may transmit, to the at least some of the multiple base stations 905, the signal pattern configuration. The transmission of the signal pattern configuration may be performed by, e.g., the signal pattern indication component 1246 and/or the transmission component 1234 of the apparatus 1202 in FIG. 12.

FIG. 12 is a diagram 1200 illustrating an example of a hardware implementation for an apparatus 1202. The apparatus 1202 may be a network entity (e.g., an LMF), a component of a network entity, or may implement network entity functionality. In some aspects, the apparatus 1202 may include a baseband unit 1204. The baseband unit 1204 may communicate through at least one transceiver 1222 (e.g., one or more RF transceivers and/or antennas) with the UE 104 or with one or more base stations. The at least one transceiver 1222 may be associated with or include a reception component 1230 and/or a transmission component 1234. The baseband unit 1204 may include a computer-readable medium/memory (e.g., a memory 1226). The baseband unit 1204 and/or the at least one processor 1228 may be responsible for general processing, including the execution of software stored on the computer-readable medium/memory. The software, when executed by the baseband unit 1204 and/or the at least one processor 1228, causes the baseband unit 1204 and/or the at least one processor 1228 to perform the various functions described supra. The computer-readable medium/memory may also be used for storing data that is manipulated by the baseband unit 1204 when executing software. The baseband unit 1204 further includes the reception component 1230, a communication manager 1232, and the transmission component 1234. The reception component 1230 and the transmission component 1234 may, in a non-limiting example, include at least one transceiver and/or at least one antenna subsystem. The communication manager 1232 includes the one or more illustrated components. The components within the communication manager 1232 may be stored in the computer-readable medium/memory and/or configured as hardware within the baseband unit 1204. The baseband unit 1204 may be a component of the RF sensing node and may include the memory 376 and/or at least one of the TX processor 316, the RX processor 370, and the controller/processor 375.

The communication manager 1232 includes a UE positioning initiation component 1250 that receives, from an AMF, a request to determine a location of a UE; transmits, to the UE, a request to report a UE capability associated with the UE positioning session; and receives, from the UE, the UE capability, where the at least some of the plurality of base stations and the signal pattern configuration for the UE positioning session are selected further based on the UE capability, e.g., as described in connection with 1002 of FIG. 10. The communication manager 1232 further includes a PRS formulation indication component 1248 that transmits, to a UE associated with the UE positioning session, an indication to receive one or more PRSs that are formulated based on one or more RSs for communication from the at least some of the plurality of base stations, e.g., as described in connection with 1004 of FIG. 10. The communication manager 1232 further includes a capability report request component 1240 that transmits, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session, e.g., as described in connection with 1006 of FIGS. 10 and/or 1106 of FIG. 11. The communication manager 1232 further includes a capability report process component 1242 that receives, from each of the plurality of base stations, the capability report, e.g., as described in connection with 1008 of FIGS. 10 and/or 1108 of FIG. 11. The communication manager 1232 further includes a BS and signal pattern configuration component 1244 that selects at least some of the plurality of base stations and a signal pattern configuration for the UE positioning session based on the capability report received from each of the plurality of base stations, e.g., as described in connection with 1010 of FIGS. 10 and/or 1110 of FIG. 11. The communication manager 1232 further includes a signal pattern indication component 1246 that transmits, to the at least some of the plurality of base stations, the signal pattern configuration, e.g., as described in connection with 1012 of FIG. 10.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for transmitting, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session (e.g., the capability report request component 1240 and/or the transmission component 1234). The apparatus 1202 includes means for receiving, from each of the plurality of base stations, the capability report (e.g., the capability report process component 1242 and/or the reception component 1230). The apparatus 1202 includes means for selecting at least some of the plurality of base stations and a signal pattern configuration for the UE positioning session based on the capability report received from each of the plurality of base stations (e.g., the BS and signal pattern configuration component 1244). The apparatus 1202 includes means for receiving, from an AMF, a request to determine a location of a UE; means for transmitting, to the UE, a request to report a UE capability associated with the UE positioning session; and means for receiving, from the UE, the UE capability, where the at least some of the plurality of base stations and the signal pattern configuration for the UE positioning session are selected further based on the UE capability (e.g., the UE positioning initiation component 1250, the reception component 1230, and/or the transmission component 1234). The apparatus 1202 includes means for transmitting, to the at least some of the plurality of base stations, the signal pattern configuration (e.g., the signal pattern indication component 1246 and/or the transmission component 1234). The apparatus 1202 includes means for transmitting, to a UE associated with the UE positioning session, an indication to receive one or more PRSs that are formulated based on one or more RSs for communication from the at least some of the plurality of base stations (e.g., the PRS formulation indication component 1248 and/or the transmission component 1234).

In one configuration, the RS for communication may include a TRS.

In another configuration, the one or more PRSs may be associated with periodic resources. In such a configuration, the indication may be transmitted via a positioning system information block.

In another configuration, if the capability report from a base station of the plurality of base stations indicates that the base station does not have the capability to formulate the RS for communication as the PRS, the apparatus 1202 includes means for excluding the base station from the at least some of the plurality of base stations for the UE positioning session.

In another configuration, if the capability report from a base station of the plurality of base stations indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting. In such a configuration, the at least one RS type includes one or more of: an AP-TRS, an SP-TRS, or a P-TRS.

In another configuration, if the capability report from a base station of the plurality of base stations indicates that the base station does not have the capability to formulate the RS for communication as the PRS but has the capability to transmit the PRS dedicated for positioning, the capability report further includes one or more of: a resource pattern associated with the PRS, a beam type associated with a transmission of the PRS, a periodicity associated with the PRS.

In another configuration, the apparatus 1202 includes means for receiving, from the at least some of the plurality of base stations, an indication of whether one or more PRSs formulated based on one or more RSs for communication are transmitted to the UE from the at least some of the plurality of base stations during an idle mode or an inactive mode of the UE, and means for selecting the at least some of the plurality of base stations for the UE positioning session based on the indication that the one or more PRSs are transmitted to the UE during the idle mode or the inactive mode of the UE.

In another configuration, the signal pattern configuration may correspond to a first PRS pattern formulated based on the PRS dedicated for positioning or a second PRS pattern formulated based on the RS for communication that is different from the first PRS pattern. In such a configuration, the signal pattern configuration may be selected further based on whether the at least some of the plurality of base stations are able to transmit the first PRS pattern, or whether the at least some of the plurality of base stations are able to transmit both the first PRS pattern and the second PRS pattern.

The means may be one or more of the components of the apparatus 1202 configured to perform the functions recited by the means. As described supra, the apparatus 1202 may include the TX Processor 316, the RX Processor 370, and the controller/processor 375. As such, in one configuration, the means may be the TX Processor 316, the RX Processor 370, and the controller/processor 375 configured to perform the functions recited by the means.

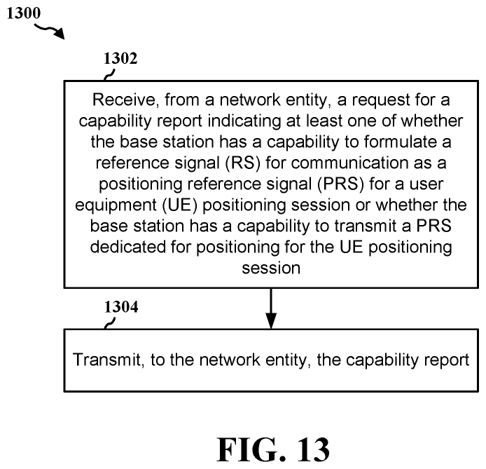

FIG. 13 is a flowchart 1300 of a method of wireless communication. The method may be performed by a base station or a component of a base station (e.g., the base station 102, 180, 310, 804, 806, 904, 906; the apparatus 1402; a processing system, which may include the memory 376 and which may be the entire base station 310 or a component of the base station 310, such as the TX processor 316 the RX processor 370, and/or the controller/processor 375). The method may enable the base station to report the type of PRS configuration supported by the base station and whether the base station is capable of formulating RS for communication to RS for positioning.

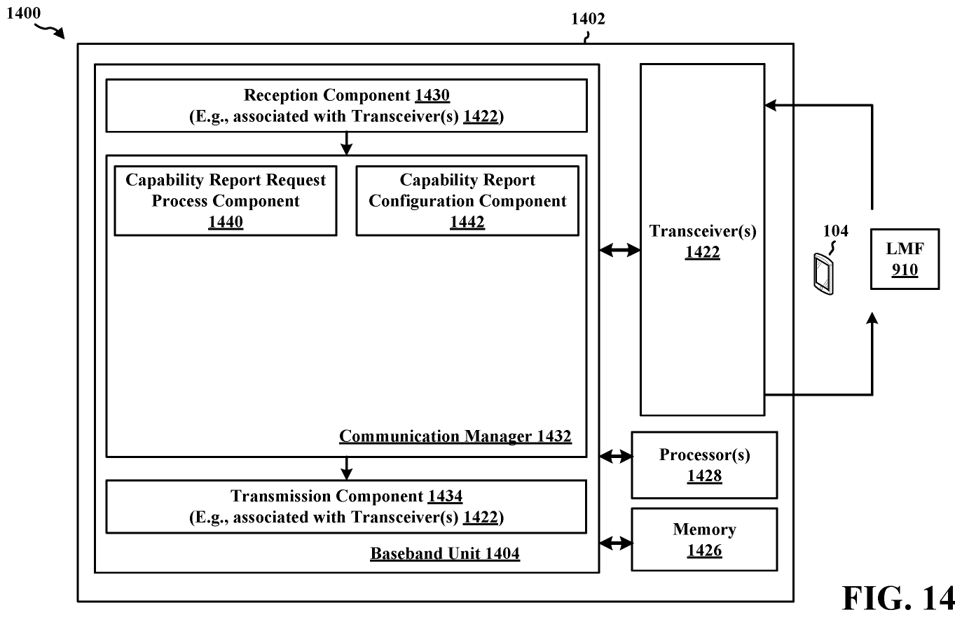

At 1302, the base station may receive, from a network entity (e.g., an LMF), a request for a capability report indicating at least one of whether the base station has a capability to formulate an RS for communication as a PRS for a UE positioning session or whether the base station has a capability to transmit a PRS dedicated for positioning for the UE positioning session, such as described in connection with FIG. 9. For example, at 914, the base station 904 and the base station 906 may receive, from the LMF 910, a request for a capability report indicating at least one of whether the base station has a capability to formulate an RS for communication as a PRS for a UE positioning session or whether the base station has a capability to transmit a PRS dedicated for positioning for the UE positioning session. The reception of the request for the capability report may be performed by, e.g., the capability report request process component 1440 and/or the reception component 1430 of the apparatus 1402 in FIG. 14.

At 1304, the base station may transmit, to the network entity, the capability report, such as described in connection with FIG. 9. For example, the base station 904 and the base station 906 may transmit, to the LMF 910, the capability report. The transmission of the capability report may be performed by, e.g., the capability report configuration component 1442 and/or the transmission component 1434 of the apparatus 1402 in FIG. 14.

In one example, the RS for communication may include TRS.

In another example, if the capability report indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting. In such an example, the at least one RS type includes one or more of: an AP-TRS, an SP-TRS, or a P-TRS.

In another example, the base station may receive, from the network entity, a signal pattern configuration for the UE positioning session based on the capability report. In such an example, the signal pattern configuration may correspond to a first PRS pattern formulated based on the PRS dedicated for positioning or a second PRS pattern formulated based on the RS for communication that is different from the first PRS pattern. In such a configuration, the signal pattern configuration may be based on whether the base station is able to transmit the first PRS pattern, or whether the base station is able to transmit both the first PRS pattern and the second PRS pattern.

In another example, if the capability report indicates that the base station does not have the capability to formulate the RS for communication as the PRS but has the capability to transmit the PRS dedicated for positioning, the capability report may further include one or more of: a resource pattern associated with the PRS, a beam type associated with transmission of the PRS, a periodicity associated with the PRS. In another example, the base station may transmit, to the network entity, a first indication of whether the base station is transmitting one or more PRSs formulated based on one or more RSs for communication to the UE during an idle mode or an inactive mode of the UE; and receive, from the network entity, a second indication to transmit the one or more PRSs to the UE based on the first indication that the one or more PRSs are transmitted to the UE during the idle mode or the inactive mode of the UE.

FIG. 14 is a diagram 1400 illustrating an example of a hardware implementation for an apparatus 1402. The apparatus 1402 may be a base station, a component of a base station, or may implement base station functionality. In some aspects, the apparatus 1402 may include a baseband unit 1404. The baseband unit 1404 may communicate through at least one transceiver 1422 (e.g., one or more RF transceivers and/or antennas) with the UE 104 or with an LMF 910. The at least one transceiver 1422 may be associated with or include a reception component 1430 and/or a transmission component 1434. The baseband unit 1404 may include a computer-readable medium/memory (e.g., a memory 1426). The baseband unit 1404 and/or the at least one processor 1428 may be responsible for general processing, including the execution of software stored on the computer-readable medium/memory. The software, when executed by the baseband unit 1404 and/or the at least one processor 1428, causes the baseband unit 1404 and/or the at least one processor 1428 to perform the various functions described supra. The computer-readable medium/memory may also be used for storing data that is manipulated by the baseband unit 1404 when executing software. The baseband unit 1404 further includes the reception component 1430, a communication manager 1432, and the transmission component 1434. The reception component 1430 and the transmission component 1434 may, in a non-limiting example, include at least one transceiver and/or at least one antenna subsystem. The communication manager 1432 includes the one or more illustrated components. The components within the communication manager 1432 may be stored in the computer-readable medium/memory and/or configured as hardware within the baseband unit 1404. The baseband unit 1404 may be a component of the RF sensing node and may include the memory 376 and/or at least one of the TX processor 316, the RX processor 370, and the controller/processor 375.

The communication manager 1432 includes a capability report request process component 1440 that receives, from a network entity, a request for a capability report indicating at least one of whether the base station has a capability to formulate an RS for communication as a PRS for a UE positioning session or whether the base station has a capability to transmit a PRS dedicated for positioning for the UE positioning session, e.g., as described in connection with 1302 of FIG. 13. The communication manager 1432 further includes a capability report configuration component 1442 that transmits, to the network entity, the capability report, e.g., as described in connection with 1304 of FIG. 13.

The apparatus may include additional components that perform each of the blocks of the algorithm in the flowchart of FIG. 13. As such, each block in the flowchart of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the baseband unit 1404, includes means for receiving, from a network entity, a request for a capability report indicating at least one of whether the base station has a capability to formulate an RS for communication as a PRS for a UE positioning session or whether the base station has a capability to transmit a PRS dedicated for positioning for the UE positioning session (e.g., the capability report request process component 1440 and/or the reception component 1430). The apparatus 1402 includes means for transmitting, to the network entity, the capability report (e.g., the capability report configuration component 1442 and/or the transmission component 1434).

In one configuration, the RS for communication may include TRS.

In another configuration, if the capability report indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting. In such a configuration, the at least one RS type includes one or more of: an AP-TRS, an SP-TRS, or a P-TRS.

In another configuration, the apparatus 1402 includes means for receiving, from the network entity, a signal pattern configuration for the UE positioning session based on the capability report. In such a configuration, the signal pattern configuration may correspond to a first PRS pattern formulated based on the PRS dedicated for positioning or a second PRS pattern formulated based on the RS for communication that is different from the first PRS pattern. In such a configuration, the signal pattern configuration may be based on whether the base station is able to transmit the first PRS pattern, or whether the base station is able to transmit both the first PRS pattern and the second PRS pattern.

In another configuration, if the capability report indicates that the base station does not have the capability to formulate the RS for communication as the PRS but has the capability to transmit the PRS dedicated for positioning, the capability report may further include one or more of: a resource pattern associated with the PRS, a beam type associated with transmission of the PRS, a periodicity associated with the PRS.

In another configuration, the apparatus 1402 includes means for transmitting, to the network entity, a first indication of whether the base station is transmitting one or more PRSs formulated based on one or more RSs for communication to the UE during an idle mode or an inactive mode of the UE; and means for receiving, from the network entity, a second indication to transmit the one or more PRSs to the UE based on the first indication that the one or more PRSs are transmitted to the UE during the idle mode or the inactive mode of the UE.

The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including a memory; at least one transceiver; and at least one processor communicatively connected to the memory and the at least one transceiver, the at least one processor configured to: transmit, to a plurality of base stations, a request for a capability report indicating at least one of whether the plurality of base stations have a capability to formulate an RS for communication as a PRS for a UE positioning session or whether the plurality of base stations have a capability to transmit a PRS dedicated for positioning for the UE positioning session; receive, from each of the plurality of base stations, the capability report; and select at least some of the plurality of base stations and a signal pattern configuration for the UE positioning session based on the capability report received from each of the plurality of base stations.

Aspect 2 is the apparatus of aspect 1, where the RS for communication includes a TRS.

Aspect 3 is the apparatus of aspect 1 or aspect 2, where if the capability report from a base station of the plurality of base stations indicates that the base station does not have the capability to formulate the RS for communication as the PRS, the at least one processor is further configured to: exclude the base station from the at least some of the plurality of base stations for the UE positioning session.

Aspect 4 is the apparatus of any of aspects 1 to 3, where if the capability report from a base station of the plurality of base stations indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting.

Aspect 5 is the apparatus of any of aspects 1 to 4, where the at least one RS type includes one or more of: an AP-TRS, an SP-TRS, or a P-TRS.

Aspect 6 is the apparatus of any of aspects 1 to 5, where the at least one processor is further configured to: receive, from an AMF, a request to determine a location of a UE; transmit, to the UE, a request to report a UE capability associated with the UE positioning session; and receive, from the UE, the UE capability, where the at least some of the plurality of base stations and the signal pattern configuration for the UE positioning session are selected further based on the UE capability.

Aspect 7 is the apparatus of any of aspects 1 to 6, where the at least one processor is further configured to: transmit, to the at least some of the plurality of base stations, the signal pattern configuration.

Aspect 8 is the apparatus of any of aspects 1 to 7, where the signal pattern configuration corresponds to a first PRS pattern formulated based on the PRS dedicated for positioning or a second PRS pattern formulated based on the RS for communication that is different from the first PRS pattern.

Aspect 9 is the apparatus of any of aspects 1 to 8, where the signal pattern configuration is selected further based on whether the at least some of the plurality of base stations are able to transmit the first PRS pattern, or whether the at least some of the plurality of base stations are able to transmit both the first PRS pattern and the second PRS pattern.

Aspect 10 is the apparatus of any of aspects 1 to 9, where if the capability report from a base station of the plurality of base stations indicates that the base station does not have the capability to formulate the RS for communication as the PRS but has the capability to transmit the PRS dedicated for positioning, the capability report further includes one or more of: a resource pattern associated with the PRS, a beam type associated with a transmission of the PRS, a periodicity associated with the PRS.

Aspect 11 is the apparatus of any of aspects 1 to 10, where the at least one processor is further configured to: transmit, to a UE associated with the UE positioning session, an indication to receive one or more PRSs that are formulated based on one or more RSs for communication from the at least some of the plurality of base stations.

Aspect 12 is the apparatus of any of aspects 1 to 11, where the one or more PRSs are associated with periodic resources.

Aspect 13 is the apparatus of any of aspects 1 to 12, where the indication is transmitted via a positioning system information block.

Aspect 14 is the apparatus of any of aspects 1 to 13, where the at least one processor is further configured to: receive, from the at least some of the plurality of base stations, an indication of whether one or more PRSs formulated based on one or more RSs for communication are transmitted to the UE from the at least some of the plurality of base stations during an idle mode or an inactive mode of the UE; and select the at least some of the plurality of base stations for the UE positioning session based on the indication that the one or more PRSs are transmitted to the UE during the idle mode or the inactive mode of the UE.

Aspect 15 is a method of wireless communication for implementing any of aspects 1 to 14.

Aspect 16 is an apparatus for wireless communication including means for implementing any of aspects 1 to 14.

Aspect 17 is a computer-readable medium storing computer executable code, where the code when executed by a processor causes the processor to implement any of aspects 1 to 14.

Aspect 15 is an apparatus for wireless communication including a memory; at least one transceiver; and at least one processor communicatively connected to the memory and the at least one transceiver, the at least one processor configured to: receive, from a network entity, a request for a capability report indicating at least one of whether the base station has a capability to formulate an RS for communication as a PRS for a UE positioning session or whether the base station has a capability to transmit a PRS dedicated for positioning for the UE positioning session; and transmit, to the network entity, the capability report.

Aspect 16 is the apparatus of aspect 15, where the RS for communication includes TRS.

Aspect 17 is the apparatus of any of aspects 15 and 16, where if the capability report indicates that the base station has the capability to formulate the RS for communication as the PRS, the capability report further includes one or more of: at least one RS type supported by the base station, a periodicity of the at least one RS type, a first indication of whether the RS for communication is able to be configured for a UE in an idle mode or an inactive mode, a maximum supported bandwidth for the RS, a duration of the RS that is able to serve as the PRS, a second indication of whether the base station is capable of formulating the RS for communication to a predefined PRS pattern, or a third indication of whether the base station supports RS muting.

Aspect 18 is the apparatus of any of aspects 15 to 17, where the at least one RS type includes one or more of: an AP-TRS, an SP-TRS, or a P-TRS.

Aspect 19 is the apparatus of any of aspects 15 to 18, where the at least one processor is further configured to: receive, from the network entity, a signal pattern configuration for the UE positioning session based on the capability report.

Aspect 20 is the apparatus of any of aspects 15 to 19, where the signal pattern configuration corresponds to a first PRS pattern formulated based on the PRS dedicated for positioning or a second PRS pattern formulated based on the RS for communication that is different from the first PRS pattern.

Aspect 21 is the apparatus of any of aspects 15 to 20, where the signal pattern configuration is based on whether the base station is able to transmit the first PRS pattern, or whether the base station is able to transmit both the first PRS pattern and the second PRS pattern.

Aspect 22 is the apparatus of any of aspects 15 to 21, where if the capability report indicates that the base station does not have the capability to formulate the RS for communication as the PRS but has the capability to transmit the PRS dedicated for positioning, the capability report further includes one or more of: a resource pattern associated with the PRS, a beam type associated with transmission of the PRS, a periodicity associated with the PRS.

Aspect 23 is the apparatus of any of aspects 15 to 22, where the at least one processor is further configured to: transmit, to the network entity, a first indication of whether the base station is transmitting one or more PRSs formulated based on one or more RSs for communication to the UE during an idle mode or an inactive mode of the UE; and receive, from the network entity, a second indication to transmit the one or more PRSs to the UE based on the first indication that the one or more PRSs are transmitted to the UE during the idle mode or the inactive mode of the UE.

Aspect 24 is a method of wireless communication for implementing any of aspects 15 to 23.

Aspect 25 is an apparatus for wireless communication including means for implementing any of aspects 15 to 23.

Aspect 26 is a computer-readable medium storing computer executable code, where the code when executed by a processor causes the processor to implement any of aspects 15 to 23.

What is claimed is:

1. An apparatus for wireless communication at a network entity, comprising:
a memory;
a transceiver; and
at least one processor communicatively connected to the memory and the transceiver, the at least one processor configured to:
transmit, to a plurality of base stations, a request for a capability report indicating at least one of whether the plurality of base stations have a capability to formulate a reference signal (RS) for communication as a positioning reference signal (PRS) for a user equipment (UE) positioning session or whether the plurality of base stations have a capability to transmit a PRS dedicated for positioning for the UE positioning session;
receive, from each of the plurality of base stations, the capability report; and
select at least some of the plurality of base stations and a signal pattern configuration for the UE positioning session based on the capability report received from each of the plurality of base stations.

2. The apparatus of claim 1, wherein the RS for communication includes a tracking reference signal (TRS).

3. The apparatus of claim 1, wherein if the capability report from a base station of the plurality of base stations indicates that the base station does not have the capability to formulate the RS for communication as the PRS, the at least one processor is further configured to:
exclude the base station from the at least some of the plurality of base stations for the UE positioning session.

4. The apparatus of claim 1, wherein if the capability report from a base station of the plurality of base stations indicates that the base station has the capability to formulate the RS for communication as the PRS, the capability report further includes one or more of:
at least one RS type supported by the base station,
a periodicity of the at least one RS type,
a first indication of whether the RS for communication is able to be configured for a UE in an idle mode or an inactive mode,
a maximum supported bandwidth (BW) for the RS,
a duration of the RS that is able to serve as the PRS,
a second indication of whether the base station is capable of formulating the RS for communication to a predefined PRS pattern, or
a third indication of whether the base station supports RS muting.

5. The apparatus of claim 4, wherein the at least one RS type includes one or more of: an aperiodic-tracking reference signal (AP-TRS), a semi-persistent-tracking reference signal (SP-TRS), or a periodic-tracking reference signal (P-TRS).

6. The apparatus of claim 1, wherein the at least one processor is further configured to:
receive, from an access and mobility management function (AMF), a request to determine a location of a UE;
transmit, to the UE, a request to report a UE capability associated with the UE positioning session; and
receive, from the UE, the UE capability, wherein the at least some of the plurality of base stations and the signal pattern configuration for the UE positioning session are selected further based on the UE capability.

7. The apparatus of claim 1, wherein the at least one processor is further configured to:
transmit, to the at least some of the plurality of base stations, the signal pattern configuration.

8. The apparatus of claim 1, wherein the signal pattern configuration corresponds to a first PRS pattern formulated based on the PRS dedicated for positioning or a second PRS pattern formulated based on the RS for communication that is different from the first PRS pattern.

9. The apparatus of claim 8, wherein the signal pattern configuration is selected further based on whether the at least some of the plurality of base stations are able to transmit the first PRS pattern, or whether the at least some of the plurality of base stations are able to transmit both the first PRS pattern and the second PRS pattern.

10. The apparatus of claim 1, wherein if the capability report from a base station of the plurality of base stations indicates that the base station does not have the capability to formulate the RS for communication as the PRS but has the capability to transmit the PRS dedicated for positioning, the capability report further includes one or more of: a resource pattern associated with the PRS, a beam type associated with a transmission of the PRS, a periodicity associated with the PRS.

11. The apparatus of claim 1, wherein the at least one processor is further configured to:
transmit, to a UE associated with the UE positioning session, an indication to receive one or more PRSs that are formulated based on one or more RSs for communication from the at least some of the plurality of base stations.

12. The apparatus of claim 11, wherein the one or more PRSs are associated with periodic resources.

13. The apparatus of claim 11, wherein the indication is transmitted via a positioning system information block (SIB).

14. The apparatus of claim 1, wherein the at least one processor is further configured to:
receive, from the at least some of the plurality of base stations, an indication of whether one or more PRSs formulated based on one or more RSs for communication are transmitted to the UE from the at least some of the plurality of base stations during an idle mode or an inactive mode of the UE; and
select the at least some of the plurality of base stations for the UE positioning session based on the indication that the one or more PRSs are transmitted to the UE during the idle mode or the inactive mode of the UE.

15. A method of wireless communication at a network entity, comprising:
transmitting, to a plurality of base stations, a request for a capability report indicating at least one of whether the plurality of base stations have a capability to formulate a reference signal (RS) for communication as a positioning reference signal (PRS) for a user equipment (UE) positioning session or whether the plurality of base stations have a capability to transmit a PRS dedicated for positioning for the UE positioning session;
receiving, from each of the plurality of base stations, the capability report; and
selecting at least some of the plurality of base stations and a signal pattern configuration for the UE positioning session based on the capability report received from each of the plurality of base stations.

16. The method of claim 15, wherein the RS for communication includes a tracking reference signal (TRS).

17. The method of claim 15, wherein if the capability report from a base station of the plurality of base stations indicates that the base station does not have the capability to formulate the RS for communication as the PRS, the method further comprising:
excluding the base station from the at least some of the plurality of base stations for the UE positioning session.

18. The method of claim 15, wherein if the capability report from a base station of the plurality of base stations indicates that the base station has the capability to formulate the RS for communication as the PRS, the capability report further includes one or more of:
at least one RS type supported by the base station,
a periodicity of the at least one RS type,
a first indication of whether the RS for communication is able to be configured for a UE in an idle mode or an inactive mode,
a maximum supported bandwidth (BW) for the RS,
a duration of the RS that is able to serve as the PRS,
a second indication of whether the base station is capable of formulating the RS for communication to a predefined PRS pattern, or
a third indication of whether the base station supports RS muting.

19. The method of claim 15, further comprising:
transmitting, to the at least some of the plurality of base stations, the signal pattern configuration.

20. The method of claim 15, further comprising:
transmitting, to a UE associated with the UE positioning session, an indication to receive one or more PRSs that are formulated based on one or more RSs for communication from the at least some of the plurality of base stations.

21. An apparatus for wireless communication at a base station, comprising:
a memory;
a transceiver; and
at least one processor communicatively connected to the memory and the transceiver, the at least one processor configured to:
receive, from a network entity, a request for a capability report indicating at least one of whether the base station has a capability to formulate a reference signal (RS) for communication as a positioning reference signal (PRS) for a user equipment (UE) positioning session or whether the base station has a capability to transmit a PRS dedicated for positioning for the UE positioning session; and
transmit, to the network entity, the capability report.

22. The apparatus of claim 21, wherein the RS for communication includes tracking reference signal (TRS).

23. The apparatus of claim 21, wherein if the capability report indicates that the base station has the capability to formulate the RS for communication as the PRS, the capability report further includes one or more of:
at least one RS type supported by the base station,
a periodicity of the at least one RS type,
a first indication of whether the RS for communication is able to be configured for a UE in an idle mode or an inactive mode,
a maximum supported bandwidth (BW) for the RS,
a duration of the RS that is able to serve as the PRS,
a second indication of whether the base station is capable of formulating the RS for communication to a predefined PRS pattern, or
a third indication of whether the base station supports RS muting.

24. The apparatus of claim 23, wherein the at least one RS type includes one or more of: an aperiodic-tracking reference signal (AP-TRS), a semi-persistent-tracking reference signal (SP-TRS), or a periodic-tracking reference signal (P-TRS).

25. The apparatus of claim 21, wherein the at least one processor is further configured to:
receive, from the network entity, a signal pattern configuration for the UE positioning session based on the capability report.

26. The apparatus of claim 25, wherein the signal pattern configuration corresponds to a first PRS pattern formulated based on the PRS dedicated for positioning or a second PRS pattern formulated based on the RS for communication that is different from the first PRS pattern.

27. The apparatus of claim 26, wherein the signal pattern configuration is based on whether the base station is able to transmit the first PRS pattern, or whether the base station is able to transmit both the first PRS pattern and the second PRS pattern.

28. The apparatus of claim 21, wherein if the capability report indicates that the base station does not have the capability to formulate the RS for communication as the PRS but has the capability to transmit the PRS dedicated for positioning, the capability report further includes one or more of: a resource pattern associated with the PRS, a beam type associated with transmission of the PRS, a periodicity associated with the PRS.

29. The apparatus of claim 21, wherein the at least one processor is further configured to:
transmit, to the network entity, a first indication of whether the base station is transmitting one or more PRSs formulated based on one or more RSs for communication to the UE during an idle mode or an inactive mode of the UE; and
receive, from the network entity, a second indication to transmit the one or more PRSs to the UE based on the first indication that the one or more PRSs are transmitted to the UE during the idle mode or the inactive mode of the UE.

30. A method of wireless communication at a base station, comprising:
receiving, from a network entity, a request for a capability report indicating at least one of whether the base station has a capability to formulate a reference signal (RS) for communication as a positioning reference signal (PRS) for a user equipment (UE) positioning session or whether the base station has a capability to transmit a PRS dedicated for positioning for the UE positioning session; and
transmitting, to the network entity, the capability report.
